(19) United States
(12) Patent Application Publication
(10) Pub. No.: US 2016/0370902 A1
(43) Pub. Date: Dec. 22, 2016

(54) SUBSTRATE ATTACHED WITH DECORATIVE MATERIAL AND MANUFACTURING METHOD THEREOF, TOUCH PANEL, AND INFORMATION DISPLAY DEVICE

(71) Applicant: FUJIFILM Corporation, Tokyo (JP)

(72) Inventors: Takashi ARIDOMI, Fujinomiya-shi (JP); Kentaro TOYOOKA, Fujinomiya-shi (JP); Tetsunori MATSUMOTO, Fujinomiya-shi (JP)

(73) Assignee: FUJIFILM Corporation, Tokyo (JP)

(21) Appl. No.: 15/256,788

(22) Filed: Sep. 6, 2016

Related U.S. Application Data
(63) Continuation of application No. PCT/JP2015/056629, filed on Mar. 6, 2015.

(30) Foreign Application Priority Data
Mar. 7, 2014 (JP) 2014-045111

(51) Int. Cl. G06F 3/044; B32B 27/06

(52) U.S. Cl. CPC G06F 3/044; B32B 27/06; G06F 2203/04103; B32B 2307/202; B32B 2307/402; B32B 2451/00; B32B 2457/20; B32B 2457/208

(57) ABSTRACT

An object of the present invention is to provide a substrate attached with a decorative material in which a problem such as the disconnection of a conductive layer is solved, and a manufacturing method thereof, a touch panel, and an information display device. According to the present invention, there is provided a substrate attached with a decorative material, including: a substrate; a white colored layer; a light shielding layer; and a conductive layer, in this order, in which the substrate attached with a decorative material includes a light transmitting region transmitting light in a thickness direction, a decorative material configured of the white colored layer and the light shielding layer is laminated on the substrate to surround the light transmitting region and includes a tilt portion which is formed such that a thickness of the decorative material becomes thin towards the inside of the light transmitting region on an inner edge of the decorative material, and a tilt angle between a surface of the tilt portion and a surface of the substrate is 10 degrees to 60 degrees.

### CROSS-REFERENCE TO RELATED APPLICATIONS

The present application is a continuation of PCT/JP2015/56629 filed on Mar. 6, 2015 and claims priority under 35 U.S.C. §119 of Japanese Patent Application No. 45111/2014 filed on Mar. 7, 2014.

### BACKGROUND OF THE INVENTION

1. Field of the Invention

The present invention relates to a substrate attached with a decorative material and a manufacturing method thereof, a touch panel, and an information display device.

2. Description of the Related Art

In electronic devices such as a mobile phone, a car navigation system, a personal computer, a ticket machine, and a terminal of a bank, recently, a touch panel type input device has been arranged on the surface of a liquid crystal device or the like, and a finger, a touch pen, or the like has been brought into contact with a portion in which an instruction image is displayed with reference to an instruction image displayed on an image display region of the liquid crystal device, and thus, information corresponding to the instruction image has been input.

Examples of such an input device (a touch panel) include a resistance film type input device, an electrostatic capacitance type input device, and the like. The electrostatic capacitance type input device has an advantage of simply forming a light transmitting conductive film on one substrate. In an electrostatic capacitance type touch panel of a touch panel integrated with cover glass (OGS: One Glass Solution), a front plate is integrated with the electrostatic capacitance type input device, and thus, a reduction in thickness/weight is able to be obtained.

In such an electrostatic capacitance type input device, in order to make a routing circuit or the like of the display device invisible to a user and to have a good appearance, a decorative material is formed into the shape of a frame surrounding an information display unit (also referred to as an image display unit and a light transmitting region) which comes into contact with a finger, a touch pen, or the like, and decoration is performed. In JP2012-88934A, a decorative material is disclosed in which the decorative material is laminated to surround a light transmitting region, and a tilt portion is formed on the inner edge of the decorative material such that the thickness of the decorative material becomes thinner towards the inside.

### SUMMARY OF THE INVENTION

However, as a result of intensive studies of the present inventors, it has been found that in a case where a level difference in film thicknesses between the decorative material and a portion of a substrate on which the decorative material is not formed occurs, and a conductive layer is provided on the decorative material, a problem such as the disconnection of the conductive layer occurs due to the level difference in the film thickness. In JP2012-88934A, such a problem is not disclosed at all.

The present invention has been made in order to solve the problem described above, and an object of the present invention is to provide a substrate attached with a decorative material in which a problem such as the disconnection of a conductive layer is solved, and a manufacturing method thereof, a touch panel, and an information display device.

As a result of intensive studies of the present inventors for attaining the object described above, it has been found that the problem such as the disconnection of the conductive layer is able to be solved by disposing a decorative material such that a tilt angle between the surface of a tilt portion which is formed such that the thickness of the decorative material becomes thin towards the inside of a light transmitting region and the surface of a substrate becomes a predetermined angle, and thus, the present invention has been completed. Furthermore, in JP2012-88934A, it is disclosed that a tilt portion is disposed in the decorative material, but in JP2012-88934A, the decorative material is not disclosed in detail, and thus, a method of obtaining a desired tilt angle (a taper angle) or the like is also not disclosed.

Specifically, the present invention has the following configurations.

<1> A substrate attached with a decorative material, comprising: a substrate; a white colored layer; a light shielding layer; and a conductive layer, in this order, in which the substrate attached with a decorative material includes a light transmitting region transmitting light in a thickness direction, a decorative material configured of the white colored layer and the light shielding layer is laminated on the substrate to surround the light transmitting region and includes a tilt portion which is formed such that a thickness of the decorative material becomes thin towards the inside of the light transmitting region on an inner edge of the decorative material, and a tilt angle between a surface of the tilt portion and a surface of the substrate is 10 degrees to 60 degrees.

<2> The substrate attached with a decorative material according to <1>, in which the light shielding layer is a thermally crosslinking resin.

<3> The substrate attached with a decorative material according to <2>, in which the thermally crosslinking resin is a resin having a siloxane bond in a main chain.

<4> The substrate attached with a decorative material according to any one of <1> to <3>, in which the white colored layer contains a resin having a siloxane bond in a main chain.

<5> The substrate attached with a decorative material according to <3> or <4>, in which the resin having a siloxane bond in a main chain is a methyl silicone resin.

<6> The substrate attached with a decorative material according to any one of <1> to <5>, in which a difference between a width of the white colored layer on the substrate side and a width of the light shielding layer is less than or equal to 200 μm.

<7> A manufacturing method of the substrate attached with a decorative material according to any one of <1> to <6>, comprising: a step of transferring a light shielding layer and a white colored layer onto a substrate from a film transfer material including at least a temporary support, the light shielding layer, and the white colored layer in this order, and then, removing the temporary support; or a step of transferring a white colored layer onto a substrate from a film transfer material including a temporary support and the white colored layer, and then, removing the temporary support, and transferring a light shielding layer onto the white colored layer from a film transfer material including at least a temporary support and the light shielding layer, and then, removing the temporary support.

<8> The manufacturing method of the substrate attached with a decorative material according to <7>, in which the tilt portion is formed by contracting the light shielding layer.

<9> The manufacturing method of the substrate attached with a decorative material according to <7> or <8>, in which the tilt portion is formed by being heated at 50° C. to 300° C.

<10> A touch panel, comprising: the substrate attached with a decorative material according to any one of <1> to <6>.

<11> An information display device, comprising: the touch panel according to <10>.

According to the present invention, it is possible to provide a substrate attached with a decorative material in which a problem such as the disconnection of a conductive layer is solved, and a manufacturing method thereof, a touch panel, and an information display device.

### BRIEF DESCRIPTION OF THE DRAWINGS

FIG. 1 is a partially enlarged sectional view illustrating an example of a decorative material.

FIG. 2 is a partially enlarged sectional view illustrating another example of the decorative material.

FIG. 3 is a partially enlarged sectional view illustrating still another example of the decorative material.

FIG. 4 is a partially enlarged sectional view illustrating a tilt angle between a tilt portion and a substrate.

FIG. 5 is a schematic sectional view illustrating a configuration of an example of a touch panel of the present invention using a substrate attached with a decorative material of the present invention.

FIG. 6 is a schematic sectional view illustrating a configuration of another example of the touch panel of the present invention using the substrate attached with a decorative material of the present invention.

FIG. 7 is an explanatory diagram illustrating an example of a front plate of the touch panel of the present invention.

FIG. 8 is an explanatory diagram illustrating an example of a first transparent electrode pattern and a second transparent electrode pattern of the touch panel of the present invention.

FIG. 9 is a top view illustrating an example of reinforced glass in which an opening portion is formed.

FIG. 10 is a top view illustrating an example of a touch panel of the present invention in which a white colored layer and a light shielding layer are formed.

FIG. 11 is a top view illustrating an example of a touch panel of the present invention in which a first transparent electrode pattern is formed.

FIG. 12 is a top view illustrating an example of a touch panel of the present invention in which a first transparent electrode pattern and a second transparent electrode pattern are formed.

FIG. 13 is a top view illustrating an example of a touch panel of the present invention in which a conductive element is formed separately from the first transparent electrode pattern and the second transparent electrode pattern.

### DESCRIPTION OF THE PREFERRED EMBODIMENTS

Hereinafter, a substrate attached with a decorative material of the present invention, a manufacturing method thereof, a touch panel, and an information display device will be described in detail.

The following description of configuration requirements is based on representative embodiments of the present invention, but the present invention is not limited to the embodiments. Furthermore, herein, a numerical range denoted by using “to” indicates a range including numerical values before and after “to” as the lower limit value and the upper limit value.

[Substrate Attached with Decorative Material]

A substrate attached with a decorative material of the present invention includes a substrate, a white colored layer, a light shielding layer, and a conductive layer in this order, the substrate attached with a decorative material includes a light transmitting region transmitting light in a thickness direction, a decorative material configured of the white colored layer and the light shielding layer is laminated on the substrate to surround the light transmitting region and includes a tilt portion which is formed such that a thickness of the decorative material becomes thin towards the inside of the light transmitting region on the inner edge of the decorative material, and a tilt angle between the surface of the tilt portion and the surface of the substrate is 10 degrees to 60 degrees. The decorative material includes the tilt portion, and the tilt angle between the surface of the tilt portion and the surface of the substrate is 10 degrees to 60 degrees, and thus, a level difference in a film thicknesses between the decorative material and a portion of the substrate on which the decorative material is not formed is relaxed, and a problem such as the disconnection of the conductive layer on the light shielding layer rarely occurs.

Hereinafter, a preferred embodiment of the substrate attached with a decorative material of the present invention will be described.

<Properties of Substrate Attached with Decorative Material>

The “decorative material” in the substrate attached with a decorative material of the present invention indicates a laminated body of the white colored layer and the light shielding layer. In a case where the decorative material is obtained by transferring only the white colored layer onto the substrate, an optical concentration decreases, and when the substrate attached with a decorative material which is able to be obtained by the manufacturing method of the present invention is used as a substrate of a display device, a light leakage in the display device or a circuit frame may be observed. In the substrate attached with a decorative material of the present invention, the light leakage or the like is able to be suppressed by a configuration including the white colored layer and the light shielding layer in this order from the substrate (a film or glass) side.

In the substrate attached with a decorative material of the present invention, the optical concentration of the substrate attached with a decorative material is preferably 3.5 to 6.0, is more preferably 4.0 to 5.5, and is particularly preferably 4.5 to 5.0.

In the substrate attached with a decorative material of the present invention, an L value of the tint of a substrate with a decorative material on the substrate side is preferably 85 to 95, is more preferably 86 to 95, is particularly preferably 87 to 95, and is more particularly preferably 88 to 95, in an SCI index. Further, in the substrate attached with a decorative material of the present invention, it is preferable that the L value of the substrate with a decorative material on the substrate side after being subjected to a high temperature treatment at 280° C. for 30 minutes is in the range described above in the SCI index from the viewpoint of improving the tint after deposition of the conductive layer on the light shielding layer by sputtering.

In the substrate attached with a decorative material of the present invention, a b value of the tint of the substrate with a decorative material on the substrate side is preferably 1.5 to 4.0, is more preferably 1.5 to 3.8, is particularly preferably 1.5 to 3.6, and is more particularly preferably 1.5 to 3.4, in the SCI index. Further, in the substrate attached with a decorative material of the present invention, it is preferable that the b value of the substrate with a decorative material on the substrate side after being subjected to a high temperature treatment at 280° C. for 30 minutes is in the range described above in the SCI index from the viewpoint of improving the tint after the deposition of the conductive layer on the light shielding layer by sputtering.

The decorative material of the present invention is a frame-like pattern around the light transmitting region (a display region) formed on a non-contact side of a front plate of the touch panel, and is formed in order to prevent routing wiring or the like from being observed or to perform decoration.

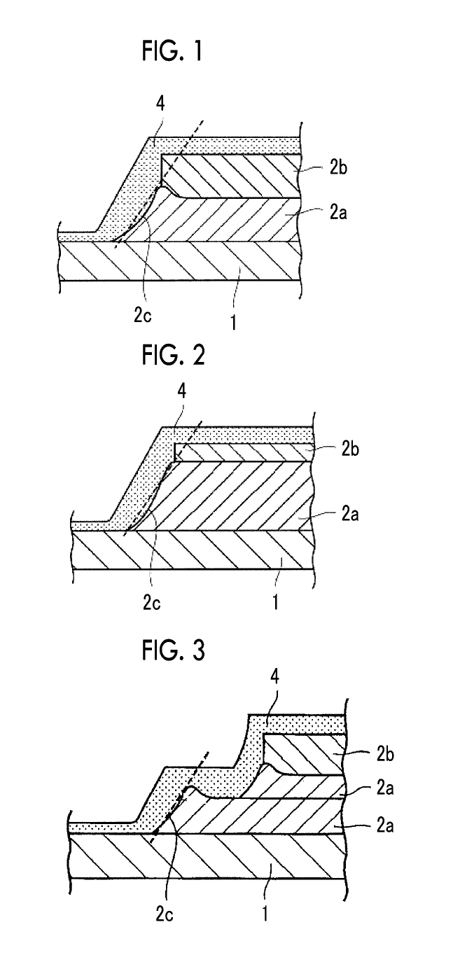

As illustrated in examples of FIG. 1 to FIG. 3, a tilt portion 2c formed such that the thickness of the decorative material becomes thin towards the inside of the light transmitting region is provided on the inner edge of a decorative material which is a laminated body of a white colored layer 2a and a light shielding layer 2b and is disposed on a substrate 1. A conductive layer 6 is formed on the decorative material, and extends to the substrate 1 along the tilt portion 2c of the decorative material.

By disposing the tilt portion, the level difference in the film thicknesses between the decorative material and the portion of the substrate on which the decorative material is not formed is relaxed, or the problem such as the disconnection of the conductive layer rarely occurs.

A formation method of the tilt portion is not particularly limited, and examples of the formation method include a method of forming the tilt portion by contracting the light shielding layer by heating, a method of forming the tilt portion by melting a white layer by heating, and the like, and the method of forming the tilt portion by contacting the light shielding layer by heating is preferable. By contracting a light shielding portion by heating, the white colored layer on the light shielding portion side is also contracted following the light shielding layer, and the white colored layer on the substrate side is not contracted following the light shielding layer, and thus, the tilt portion is able to be formed. The formation of the tilt portion by contracting the light shielding layer by heating will be described below.

The shape of the tilt portion 2c in the decorative material is not particularly limited, and for example, the tilt portion 2c may have a shape including a protruding projection as illustrated in the examples of FIG. 1 and FIG. 3, or may have a shape connected with a smooth curve as illustrated in the example of FIG. 2. In addition, as illustrated in FIG. 1 to FIG. 3, in the tilt portion 2c, the thickness of the white colored layer 2a may be thin towards the inside of the light transmitting region, and the thickness of the light shielding layer 2b may be thin towards the inside of the light transmitting region, as with the white colored layer 2a. As illustrated in the example of FIG. 3, the decorative material may be an embodiment in which two or more white colored layers 2a are laminated.

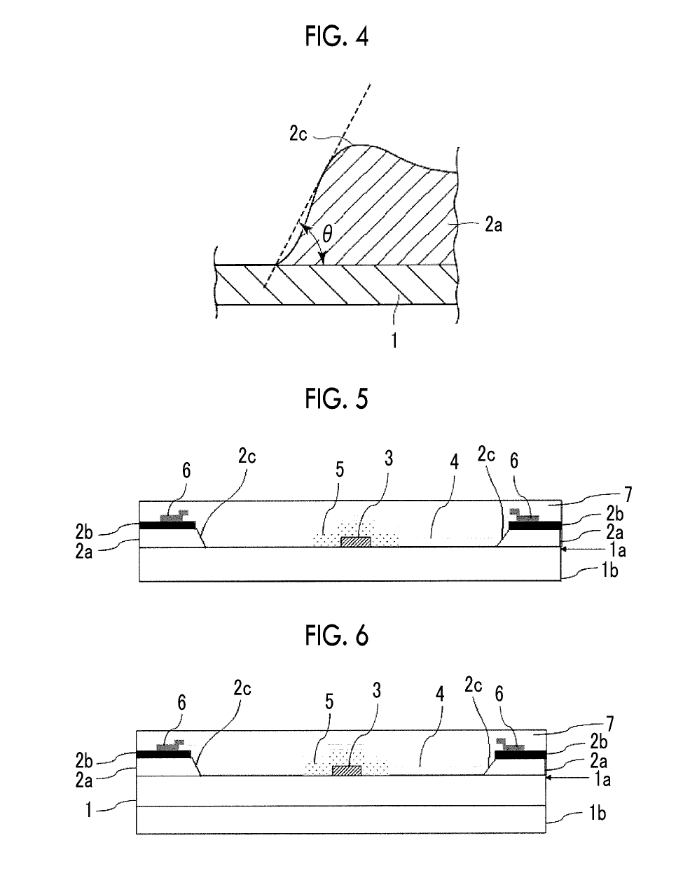

A tilt angle θ between the surface of the tilt portion and the surface of the substrate of the present invention illustrated in FIG. 4 is 10 degrees to 60 degrees, and is more preferably 15 degrees to 55 degrees. In a case where the tilt angle θ is less than 10 degrees, a portion increases in which the light shielding layer is not provided on the white colored layer, an abnormal appearance, that is, a region having a low optical concentration increases, and thus, the light leakage in the display device or the circuit frame may be observed. In contrast, in a case where the tilt angle θ is greater than 60 degrees, the problem such as the disconnection of the conductive layer may occur.

As illustrated by a dotted line of FIGS. 1 to 4, the tilt angle θ is a tilt angle between a plane which is obtained by approximating the surface of the tilt portion to a plane and the surface of the substrate. The tilt angle θ is able to be obtained by cutting the substrate, and by measuring an angle tilting to the substrate from a sectional direction using an optical microscope.

In a case where the tilt portion is formed by contracting the light shielding layer by heating, it is possible to form a tilt portion having a desired tilt angle by changing the type and/or the composition of a resin configuring the white colored layer and/or the light shielding layer.

In the present invention, it is preferable that the tilt angle θ is set such that a difference between the width of the white colored layer on the substrate side and the width of the light shielding layer is less than or equal to 200 μm. According to such a configuration, it is possible to solve the problem such as the abnormal appearance and the disconnection of the conductive layer.

The difference (an edge difference) between the width of the white colored layer on the substrate side and the width of the light shielding layer is preferably less than or equal to 200 μm, is preferably 5 μm to 100 μm, and is more preferably 10 μm to 90 μm.

The width of the white colored layer on the substrate side indicates the width of the white colored layer on a side in contact with the substrate in the white colored layer.

<Substrate>

Various substrates are able to be used as the substrate which is used in the substrate attached with a decorative material of the present invention, and it is preferable that the substrate described above is a film substrate, and it is more preferable that a substrate which is not optically distorted or a substrate having high transparency is used as the substrate. In the substrate attached with a decorative material of the present invention, it is preferable that the total light transmittance of the substrate described above is greater than or equal to 80%.

Examples of a specific material in a case where the substrate described above is a film substrate are able to include polyethylene terephthalate (PET), polyethylene naphthalate, polycarbonate (PC), triacetyl cellulose (TAC), and a cycloolefin polymer (COP).

The substrate described above may be glass or the like.

In the substrate attached with a decorative material of the present invention, it is preferable that the substrate described above is selected from glass, TAC, PET, PC, COP, or a silicone resin (herein, a silicone resin or polyorganosiloxane is not limited to the narrow sense denoted by a structural unit formula of R₂SiO, but includes a silsesquioxane compound denoted by a structural unit formula of RSiO_{1.5}), and it is preferable that the substrate described above is selected from glass, a cycloolefin polymer, or a silicone resin.

It is preferable that the silicone resin contains cage type polyorganosiloxane as a main component, and it is more preferable that the silicone resin contains a cage type silsesquioxane as a main component. Furthermore, a main component of a composition or a layer indicates a component which is contained in the composition or the layer in the amount of greater than or equal to 50 mass %. A silicone resin disclosed in JP4142385B, JP4409397B, JP5078269B, JP4920513B, JP4964748B, JP5036060B, and each publication of JP2010-96848A, JP2011-194647A, JP2012-183818A, JP2012-184371A, and JP2012-218322A is able to be used as the silicone resin or a substrate containing the silicone resin, and the contents thereof are incorporated in the present invention.

In addition, various functions may be added to the surface of the substrate. Specifically, examples of a functional layer are able to include an antireflection layer, an antiglare layer, a retardation layer, a view angle enhancement layer, a scratch resistance layer, a self-restoring layer, an antistatic layer, an antifouling layer, an antielectromagnetic wave layer, and a conductive layer.

In the substrate attached with a decorative material of the present invention, it is preferable that the substrate described above includes the conductive layer on the surface of the substrate. A conductive layer disclosed in JP2009-505358A is able to be preferably used as the conductive layer described above.

It is preferable that the substrate described above further includes at least one of a scratch resistance layer or an antiglare layer.

In the substrate attached with a decorative material of the present invention, the film thickness of the substrate described above is preferably 35 μm to 200 μm, is more preferably 40 μm to 150 μm, and is particularly preferably 40 μm to 100 μm.

In addition, in order to increase the adhesiveness of a colored layer by lamination in a transfer step, it is possible to perform a surface treatment with respect to the non-contact surface of the substrate (the front plate) in advance. It is preferable that a surface treatment using a silane compound (a silane coupling treatment) is performed as the surface treatment described above. A silane coupling agent having a functional group which interacts with a photosensitive resin is preferable as a silane coupling agent. For example, an aqueous solution of a silane coupling liquid (N-β(aminoethyl)γ-aminopropyl trimethoxy silane of 0.3 mass %, Product Name: KBM603, manufactured by Shin-Etsu Chemical Co., Ltd.) is sprayed by a shower for 20 seconds, and thus, pure water shower washing is performed. After that, a reaction is performed by heating. A heating bath may be used, and the reaction is able to be accelerated by preheating the substrate in a laminator.

<White Colored Layer>

The substrate attached with a decorative material of the present invention includes the white colored layer between the substrate described above and the light shielding layer described above. A resin forming the white colored layer described above is not particularly limited, but a resin having a siloxane bond in a main chain is preferable. In addition, it is preferable that the white colored layer described above contains a pigment.

(Resin Having Siloxane Bond in Main Chain)

It is preferable that the white colored layer described above contains the resin having a siloxane bond in a main chain. Here, the substrate attached with a decorative material of the present invention may contain a component other than the pigment described above in the white colored layer described above unless contrary to the gist of the present invention.

The resin having a siloxane bond in a main chain described above is not particularly limited, but a silicone-based resin is preferable as the resin, and a methyl silicone resin having a methyl group is preferable.

A known silicone-based resin is able to be used as the silicone-based resin. A methyl-based straight silicone resin, a methyl phenyl-based straight silicone resin, an acrylic resin-modified silicone resin, a polyester resin-modified silicone resin, an epoxy resin-modified silicone resin, an alkyd resin, a modified silicone resin, a rubber-based silicone resin, and the like are able to be used.

Among them, the methyl-based straight silicone resin, the methyl phenyl-based straight silicone resin, and the acrylic resin-modified silicone resin are more preferable, and the methyl-based straight silicone resin and the methyl phenyl-based straight silicone resin are particularly preferable.

Only one type of the resin having a siloxane bond in a main chain described above may be used, or two or more types thereof may be used by being mixed. It is possible to control film physical properties by mixing the resins at an arbitrary ratio.

The resin having a siloxane bond in a main chain described above may be used by being dissolved in an organic solvent or the like, and for example, is able to be used by being dissolved in a xylene solution or a toluene solution.

In addition, it is preferable that a known compound is added to the resin having a siloxane bond in a main chain described above as a polymerization catalyst from the viewpoint of increasing curing properties, and it is more preferable that a zinc-based polymerization catalyst is added.

The weight-average molecular weight of the resin having a siloxane bond in a main chain described above is preferably 1,000 to 5,000,000, is more preferably 2,000 to 3,000,000, and is particularly preferably 2,500 to 3,000,000. In a case where the molecular weight is greater than or equal to 1,000, film forming properties become excellent. The weight-average molecular weight, for example, is able to be measured by a gel permeation chromatography (GPC). Specifically, the measurement is able to be performed in the following conditions.
Column: GPC Column TSKgelSuper HZM-H (manufactured by TOSOH CORPORATION)
Solvent: Tetrahydrofuran
Standard Substance: Monodispersed Polystyrene

The component other than the pigment which may be contained in the white colored layer described above is not particularly limited, and a known pigment dispersion stabilizer, a known coating auxiliary, and the like are able to be used in addition to a known binder resin and the resin having a siloxane bond in a main chain described above, and it is desirable that the tint of the white colored layer described above is not changed, or is changed to a desired tint.

The ratio of the resin having a siloxane bond in a main chain described above to the component other than the pigment described above which is contained in the white colored layer described above is preferably greater than or equal to 80 mass %, and is more preferably greater than or equal to 90 mass %, from the viewpoint of obtaining the effect of the present invention.

It is preferable that the content of the resin having a siloxane bond in a main chain described above and the component other than the pigment described above in the white colored layer described above is greater than or equal to 30 mass % with respect to the total solid content of the white colored layer described above. In a case where the content of the resin having a siloxane bond in a main chain described above and the component other than the pigment described above is in the range described above, a preferred influence is able to be provided to the tint of the white colored layer of the present invention.

The content of the resin having a siloxane bond in a main chain described above and the component other than the pigment described above in the white colored layer described above is more preferably 30 mass % to 70 mass %, is even more preferably 40 mass % to 70 mass %, and is more particularly preferably 45 mass % to 65 mass %.

(Curing Catalyst)

In order to form a cured film by accelerating a crosslinking reaction of the resin having a siloxane bond in a main chain described above, a condensation reaction curing catalyst (also referred to as a polymerization catalyst) may be used. The condensation reaction curing catalyst according to the present invention is a condensation catalyst containing a metal salt, and more preferably, an organic acid metal salt.

A known condensation catalyst of the related art is preferably used as a condensation catalyst (b) formed of the metal salt (excluding an alkaline metal salt and an alkaline earth metal salt), and more preferably, the organic acid metal salt (excluding an alkaline metal salt and an alkaline earth metal salt). That is, examples of the component (b) are able to include an aluminum salt, a tin salt, a lead salt, or a transition metal salt of an organic acid, and the organic acid and the metal ions described above may form a complex salt represented by a chelate structure. A condensation catalyst containing one type or two or more types of metals selected from aluminum, titanium, iron, cobalt, nickel, zinc, zirconium, cobalt, palladium, tin, mercury, or lead is particularly preferable as the component (b), and an organic acid zirconium salt, an organic acid tin salt, and an organic acid aluminum salt are most preferably used.

Specific examples of the condensation catalyst which is the component (b) include an organic acid tin salt such as dibutyl tin diacetate, dibutyl tin dioctate, dibutyl tin dilaurate, dibutyl tin dimalate, dioctyl tin dilaurate, dioctyl tin dimalate, and tin octylate; an organic acid titanium salt such as tetra(i-propyl) titanate, tetra(n-butyl) titanate, dibutoxy bis(acetyl acetonate) titanium, isopropyl triisostearoyl titanate, isopropyl tris(dioctyl pyrophosphate) titanate, and bis(dioctyl pyrophosphate) oxy acetate titanate; an organic acid zirconium salt such as tetrabutyl zirconate, tetrakis(acetyl acetonate) zirconium, tetraisobutyl zirconate, butoxy tris(acetyl acetonate) zirconium, zirconium naphthenate, and zirconium octylate; an organic acid aluminum salt such as tris(ethyl acetoacetate) aluminum and tris(acetyl acetonate) aluminum; and an organic acid metal salt such as zinc naphthenate, zinc formate, zinc acetyl acetonate, iron acetyl acetonate, cobalt naphthenate, and cobalt octylate. In addition, CAT-AC, D-15, D, and D-25 (which are manufactured by Shin-Etsu Chemical Co., Ltd.) may be used as a commercially available product.

The use amount of the catalyst described above may be the amount of catalyst, and the metal is able to be used in the amount of 0.1 mass % to 20 mass % with respect to the resin having a siloxane bond in a main chain and is able to be arbitrarily selected according to the curing conditions.

(Color Material for White Colored Layer)

In order to particularly easily observe a good appearance, it is preferable that a color material for a white colored layer described below is used in the white colored layer described above. A pigment is preferable as the color material for the white colored layer described above, and a white inorganic pigment is more preferable.

A white pigment disclosed in paragraph 0015 or paragraph 0114 of JP2005-7765A is able to be used as the white inorganic pigment described above.

Specifically, titanium oxide, zinc oxide, lithophone, light calcium carbonate, white carbon, aluminum oxide, aluminum hydroxide, and barium sulfate are preferable as the white inorganic pigment described above, and the titanium oxide and the zinc oxide are more preferable, and in the present invention, it is particularly preferable that the white colored layer described above is titanium oxide, and among them, rutile type titanium oxide or anatase type titanium oxide is more particularly preferable, and the rutile type titanium oxide is even more particularly preferable.

The surface of titanium oxide is able to be subjected to a silica treatment, an alumina treatment, a titania treatment, a zirconia treatment, an organic matter treatment, and a combination thereof.

Accordingly, it is possible to suppress the catalystic activity of the titanium oxide, and it is possible to improve heat resistance, matting properties, and the like.

The alumina treatment, the zirconia treatment, and the silica treatment are preferable as a surface treatment with respect to the surface of the titanium oxide, and a combined treatment of alumina/zirconia or a combined treatment of alumina/silica is particularly preferable, from the viewpoint of suppressing the b value of the white colored layer described above after being heated.

By setting the content ratio of the white inorganic pigment described above with respect to the total solid content of the white colored layer described above to be 20 mass % to 75 mass %, it is possible to form a decorative material in which brightness and whiteness (a small b value) after performing heating at the same degree as that at the time of depositing the conductive layer by sputtering are set to be in an excellent range, and other properties to be required are simultaneously satisfied.

The content ratio of the white inorganic pigment described above with respect to the total solid content of the white colored layer described above is more preferably 25 mass % to 60 mass %, and is even more preferably 30 mass % to 50 mass %.

Herein, the total solid content indicates the total mass of a non-volatile component in which a solvent or the like is removed from the white colored layer described above.

It is desirable that the white inorganic pigment described above (furthermore, the same applies to other pigments used in the light shielding layer described below) is used as a dispersion. The dispersion is able to be prepared by adding a composition which is obtained by mixing the white inorganic pigment described above and a pigment dispersing agent in advance to an organic solvent (or a vehicle) described below, by performing dispersion. The vehicle described above indicates a portion of a medium in which a pigment is dispersed when a coating material is in a liquid state, and contains a component (a binder) which is a liquid and forms a coated film by being bonded to the pigment described above, and a component (an organic solvent) which dissolves and dilutes the component described above.

A dispersing machine which is used at the time of dispersing the white inorganic pigment described above is not particularly limited, and examples of the dispersing machine include a known dispersing machine disclosed in Page 438 of “Dictionary of Pigments”, the first edition, written by Kunizou ASAKURA and published by Asakura Publishing Co., Ltd.; 2000, such as a kneader, a roll mill, an atto rider, a super mill, a dissolver, a homomixer, and a sand mill. Further, pulverizing using a friction force by mechanical grinding disclosed in Page 310 of the literature described above may be performed.

In the white inorganic pigment as the white inorganic pigment described above (the color material for a white colored layer) which is used in the present invention, the average particle diameter of primary particles is preferably 0.16 μm to 0.3 μm, and is more preferably 0.18 μm to 0.27 μm, from the viewpoint of dispersion stability and hiding power. Further, the average particle diameter of the primary particles is particularly preferably 0.19 μm to 0.25 μm. In a case where the average particle diameter of the primary particles is greater than or equal to 0.16 μm, the hiding power increases, the base of the light shielding layer is rarely observed, and an increase in viscosity rarely occurs. In contrast, in a case where the average particle diameter of the primary particles is less than or equal to 0.3 μm, the whiteness is sufficiently high, the hiding power is high at the same time, and the surface conditions at the time of performing coating are excellent.

Furthermore, here, the “average particle diameter of the primary particles” indicates a diameter at the time of setting an electron microscope photographic image of the particles as a circle having the same area, and the “number average particle diameter” indicates the average value of 100 particle diameters obtained from a plurality of particles described above.

In order to disperse the white inorganic pigment described above, a dispersing agent is used. The type of dispersing agent is not particularly limited, but an acrylic binder, polyester, and a silicone oligomer are preferable from the viewpoint of dispersibility. The amount of dispersing agent is required to be minimized from the viewpoint of thermal coloration after performing baking.

In contrast, in a case where the amount of dispersing agent is extremely minimized, the stability of the dispersion deteriorates, and the precipitation and the aggregation of the particles are observed. In the precipitation and the aggregation of the particles, it is effective that a dispersion binder is added in addition to the dispersing agent at the time of performing dispersion, and codispersion is performed. It is preferable that a silicone resin and a silicone oligomer are added as the dispersion binder from the viewpoint of the thermal coloration.

(Other Materials)

Examples of other materials which are able to be used in the white colored layer described above are able to include materials which are able to be used in a colored layer of a film transfer material described below, and a preferred range of the other material is also identical to a preferred range of the material which is able to be used in the colored layer of the film transfer material.

(Thickness of White Colored Layer)

In the substrate attached with a decorative material of the present invention, it is preferable that the film thickness of the white colored layer described above is 10 μm to 40 μm from the viewpoint of increasing the hiding power of the white colored layer described above.

The thickness of the white colored layer described above is more preferably 15 μm to 40 μm, and is particularly preferably 20 μm to 38 μm.

(OD of White Colored Layer)

The optical concentration (also referred to as OD) of the white colored layer described above is preferably greater than or equal to 0.5, and is particularly preferably greater than or equal to 1.0, from the viewpoint of increasing the hiding power of the white colored layer described above.

<Light Shielding Layer>

The substrate attached with a decorative material of the present invention includes the light shielding layer on the surface of the white colored layer described above on a side opposite to the substrate described above. A resin for forming the light shielding layer is not particularly limited, but a thermally crosslinking resin is preferable as the resin.

Examples of the thermally crosslinking resin include a resin having a siloxane bond in a main chain, an epoxy resin, a melamine resin, and the like, and among them, the resin having a siloxane bond in a main chain is preferable. In addition, it is preferable that the light shielding layer contains a pigment.

(Resin Having Siloxane Bond in Main Chain)

It is preferable that the light shielding layer described above contains the resin having a siloxane bond in a main chain, and in particular, a methyl silicone resin is preferable as the resin. Here, the substrate attached with a decorative material of the present invention may contain other binder resins in the light shielding layer described above unless contrary to the gist of the present invention.

The resin having a siloxane bond in a main chain described above and the component other than the pigment described above which are able to be used in the light shielding layer described above are respectively identical to those which are able to be used in the white colored layer described above.

The ratio of the resin having a siloxane bond in a main chain with respect to the component other than the pigment described above contained in the light shielding layer described above is preferably greater than or equal to 60 mass %, and is more preferably greater than or equal to 70 mass %, from the viewpoint of obtaining the effect of the present invention.

Further, in the substrate attached with a decorative material of the present invention, it is preferable that the ratio of the resin having a siloxane bond in a main chain described above with respect to the component other than the pigment described above contained in the white colored layer described above is greater than or equal to 90 mass %, and the ratio of the resin having a siloxane bond in a main chain described above with respect to the component other than the pigment described above contained in the light shielding layer described above is greater than or equal to 70 mass %. In this case, a more preferred range is identical to a more particularly preferred range and an even more particularly preferred range of the white colored layer described above or the light shielding layer described above.

(Color Material for Light Shielding Layer)

A pigment is preferable as the color material for a light shielding layer described above, and a black pigment is more preferable. Examples of the black pigment described above include carbon black, titanium black, titanium carbon, iron oxide, titanium oxide, black lead, and the like, and in the substrate attached with a decorative material of the present invention, the light shielding layer described above preferably contains at least one of titanium oxide or carbon black, and more preferably contains carbon black.

(Other Materials)

Examples of other materials which are able to be used in the light shielding layer described above are able to include the materials which are able to be used in the colored layer of the film transfer material described below, and a preferred range of the other material is also identical to a preferred range of the material which is able to be used in the colored layer of the film transfer material.

(Thickness of Light Shielding Layer)

In the substrate attached with a decorative material of the present invention, it is preferable that the film thickness of the light shielding layer described above is 1.0 μm to 5.0 μm from the viewpoint of increasing the hiding power of the light shielding layer described above.

The thickness of the light shielding layer described above is more preferably 1.0 μm to 4.0 μm, and is particularly preferably 1.5 μm to 3.0 μm.

(Optical Concentration of Light Shielding Layer)

The optical concentration (OD) of the light shielding layer described above is preferably greater than or equal to 3.5, and is particularly preferably greater than or equal to 4.0, from the viewpoint of increasing the hiding power of the light shielding layer described above.

(Surface Resistance of Light Shielding Layer)

In the substrate attached with a decorative material of the present invention, the surface resistance of the light shielding layer described above is preferably greater than or equal to 1.0×10¹⁰Ω/□, is more preferably greater than or equal to 1.0×10¹¹Ω/□, is particularly preferably greater than or equal to 1.0×10¹²Ω/□, and is more particularly preferably greater than or equal to 1.0×10¹³Ω/□. Furthermore, Ω/□ is Q per square.

<Conductive Layer>

The substrate attached with a decorative material of the present invention further includes the conductive layer on the light shielding layer described above.

A conductive layer disclosed in JP2009-505358A is able to be preferably used as the conductive layer described above. In addition, the configuration or the shape of the conductive layer will be described in the following description of a first transparent electrode pattern and a second electrode pattern, and other conductive elements in the description of the touch panel of the present invention.

In the substrate attached with a decorative material of the present invention, it is preferable that the conductive layer described above contains indium (including an indium-containing compound such as ITO or an indium alloy).

In the substrate attached with a decorative material of the present invention, the b value of the white colored layer after being subjected to a high temperature treatment is small, and thus, even in a case where the conductive layer described above is deposited by sputtering, it is possible to decrease the b value of the white colored layer of the substrate attached with a decorative material to be obtained.

<Manufacturing Method of Substrate Attached with Decorative Material>

A manufacturing method of the substrate attached with a decorative material of the present invention is not particularly limited, but it is preferable that the white colored layer described above and the light shielding layer described above are respectively prepared by a method selected from film transfer, thermal transfer printing, screen printing, and ink jet printing, and the film transfer is particularly preferable.

Specifically, the manufacturing method of the substrate attached with a decorative material of the present invention includes a step of laminating a white colored layer and a light shielding layer on a substrate in this order, and the white colored layer described above and the light shielding layer described above are able to be respectively prepared by a method selected from a method of transferring at least one of a white colored layer or a light shielding layer onto a temporary support from a film transfer material including at least one of the white colored layer described above or the light shielding layer described above, and then, removing the temporary support described above, thermal transfer printing of heating a temporary support side of a film transfer material including at least one of a white colored layer or a light shielding layer on a temporary support, and transferring at least one of a white colored layer or a light shielding layer from the temporary support, screen printing of a composition for forming a white colored layer or a composition for forming a light shielding layer, and ink jet printing of a composition for forming a white colored layer or a composition for forming a light shielding layer. In addition, the decorative material is in the shape of a frame which surrounds the light transmitting region on the substrate described above, and the manufacturing method includes a step of forming the tilt portion on the inner edge of the decorative material described above such that the thickness of the decorative material described above becomes thin towards the inside of light transmitting region described above.

The white colored layer described above and the light shielding layer described above may be formed by a combined method of a plurality of film transfer, thermal transfer printing, screen printing, and ink jet printing.

Further, in the manufacturing method of the substrate attached with a decorative material of the present invention, it is preferable that the white colored layer described above and the light shielding layer described above are formed by transferring a light shielding layer and a white colored layer onto the substrate described above from a film transfer material including at least a temporary support, the light shielding layer described above, and the white colored layer described above in this order, and then, by removing the temporary support described above, or by transferring a white colored layer onto a substrate from a film transfer material including a temporary support and the white colored layer described above, and then, by removing the temporary support described above, and by transferring a light shielding layer onto the white colored layer described above from a film transfer material including at least a temporary support and the light shielding layer described above, and then, by removing the temporary support described above.

(Film Transfer Film Transfer Material)

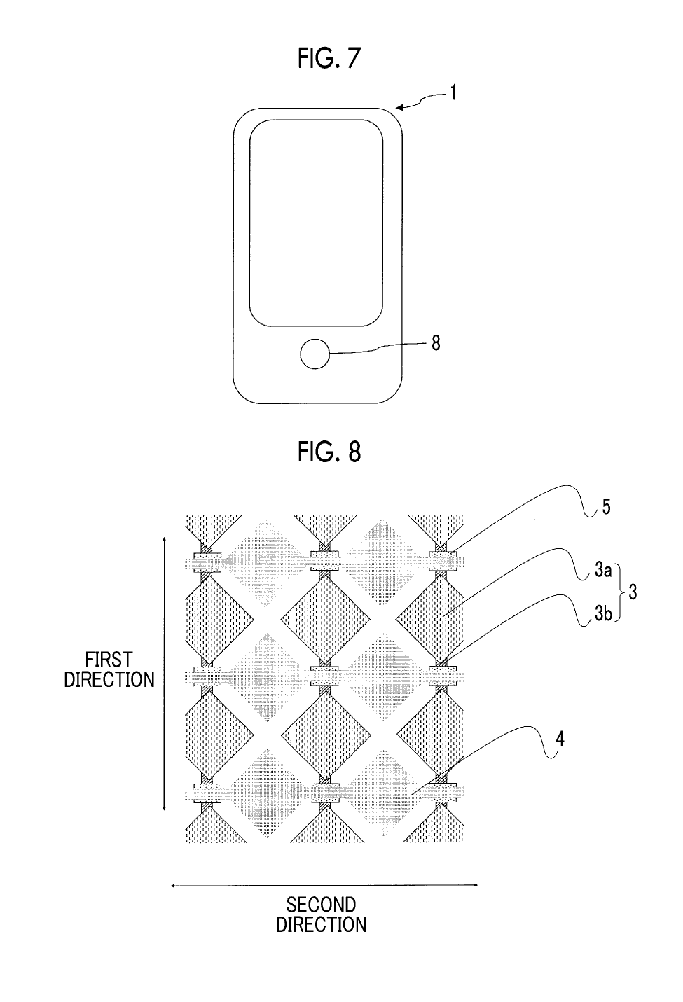

In an electrostatic capacitance type input device including an opening portion 8 having a configuration of FIG. 7, in a case where the white colored layer 2a, the light shielding layer 2b, or the like illustrated in FIG. 5 is formed by using a film transfer material, a resist component is not leaked from the opening portion even in the substrate (the front plate) including the opening portion, and in particular, the resist component is not leaked from a glass end in the white colored layer 2a or the light shielding layer 2b in which it is necessary to form a light shielding pattern to the vicinity of the boundary of the front plate, and thus, the back side of the substrate is not contaminated, and a touch panel having an advantage such as a reduction in thickness/weight is able to be manufactured by a simple step.

It is preferable that the film transfer material described above includes a temporary support, the light shielding layer described above, and the white colored layer described above. Furthermore, it is preferable that the light shielding layer and the white colored layer of the film transfer material described above have the same composition as that of the light shielding layer and the white colored layer of the substrate attached with a decorative material of the present invention, and the light shielding layer and the white colored layer of the film transfer material described above may have a different composition according to a manufacturing step after being transferred onto the substrate described above. For example, in a case where the light shielding layer and the white colored layer of the film transfer material described above contain a polymerizable compound, in the light shielding layer and the white colored layer of the substrate attached with a decorative material of the present invention, the content ratio of the polymerizable compound described above may be changed.

In addition, the colored layer described above included in the film transfer material described above contains at least a color material and a binder resin.

Hereinafter, in the film transfer material which is used in the manufacturing method of the substrate attached with a decorative material of the present invention, a transfer material preparation method and each element configuring the film transfer material will be described in detail.

—Light Shielding Layer and White Colored Layer (Colored Layer)—

The film transfer material described above includes at least one of a light shielding layer or a white colored layer (hereinafter, also collectively referred to as a colored layer).

The light shielding layer described above and the white colored layer described above included in the transfer material described above are transferred onto a substrate described below, and thus, it is possible to form the light shielding layer described above and the white colored layer described above of the substrate attached with a decorative material of the present invention.

(1) Material of Colored Layer

The colored layer described above contains the color material described above and a binder resin material for forming the color material described above as a colored layer. In addition, it is preferable that the colored layer described above further contains a polymerizable compound and a polymerization initiator according to the environment and the application to be used. In addition, the colored layer described above is able to contain an antioxidant and a polymerization inhibitor.

(1-1) Color Material

The color materials which are used in the light shielding layer and the white colored layer of the substrate attached with a decorative material of the present invention are able to be respectively used as the color material of the film transfer material described above.

(1-2) Binder Resin

The binder resin of the film transfer material described above is not particularly limited except that the binder resin includes at least one type of the resin having a siloxane bond in a main chain described above which is used in the light shielding layer described above and the white colored layer described above of the substrate attached with a decorative material of the present invention, and a resin which is able to be transferred onto the substrate after forming the colored layer on the temporary support is able to be used as the binder resin.

(1-3) Antioxidant

An antioxidant may be added to the colored layer described above. In particular, in a case where the colored layer described above is a white layer, it is preferable that the antioxidant is added. A hindered phenolic antioxidant, a semi-hindered phenolic antioxidant, a phosphoric acid-based antioxidant, and a hybrid type antioxidant having phosphoric acid/hindered phenol in the molecules are able to be used as the antioxidant described above.

The phosphoric acid-based antioxidant, for example, IRGAFOS168 (manufactured by BASF SE) is preferable as the antioxidant which is used in the present invention, from the viewpoint of suppressing coloration.

(1-4) Solvent

In addition, a solvent disclosed in paragraphs 0043 to 0044 of JP2011-95716A is able to be used as a solvent at the time of manufacturing the colored layer described above of a transfer film by coating. Specifically, cyclohexanone, methyl ethyl ketone, and the like are preferable.

(1-5) Additive

Further, other additives may be used in the colored layer described above. Examples of the additive described above include a surfactant disclosed in paragraph 0017 of JP4502784B and paragraphs 0060 to 0071 of JP2009-237362A, a thermal polymerization inhibitor disclosed in paragraph 0018 of JP4502784B, and other additives disclosed in paragraphs 0058 to 0071 of JP2000-310706A.

In addition, MEGAFAC F-780F (manufactured by DIC Corporation) and the like may be added as a coating auxiliary.

—Temporary Support—

The transfer material described above includes the temporary support.

A temporary support which has flexibility and is not considerably deformed, contracted, or stretched under pressurization, or pressurization and heating is preferable as the temporary support described above. Examples of such a temporary support are able to include a polyethylene terephthalate film, a tricellulose acetate film, a polystyrene film, a polycarbonate film, and the like, and among them, a biaxially stretched polyethylene terephthalate film is particularly preferable.

The thickness of the temporary support is not particularly limited, but is preferably 5 μm to 300 μm, and is more preferably 20 μm to 200 μm.

In addition, the temporary support may be transparent, and may contain dye silicon, alumina sol, a chromium salt, a zirconium salt, and the like.

In addition, conductivity is able to be provided to the temporary support by a method or the like disclosed in JP2005-221726A.

—Thermoplastic Resin Layer—

The transfer material described above may include at least one thermoplastic resin layer. It is preferable that the thermoplastic resin layer described above is disposed between the temporary support described above and the colored layer described above. That is, it is preferable that the transfer material described above includes the temporary support described above, the thermoplastic resin layer described above, and the colored layer described above in this order.

An organic polymer substance disclosed in JP1993-72724A (JP-H05-72724A) is preferable as a component which is used in the thermoplastic resin layer described above, and it is particularly preferable that the component is selected from organic polymer substances of which a softening point obtained by a Vicat method (specifically, a polymer softening point measurement method of American Society for Testing and Materials ASTMD1235) is lower than or equal to approximately 80° C.

Specifically, examples of the organic polymer substance include organic polymers such as polyolefin such as polyethylene and polypropylene, an ethylene copolymer such as ethylene and vinyl acetate, or a saponified product thereof, ethylene and acrylic acid ester, or a saponified product thereof, a vinyl chloride copolymer such as polyvinyl chloride, vinyl chloride, vinyl acetate, and a saponified product thereof, polyvinylidene chloride, a vinylidene chloride copolymer, a styrene copolymer such as polystyrene, styrene, and (meth)acrylic acid ester, or a saponified product thereof, a vinyl toluene copolymer such as polyvinyl toluene, vinyl toluene, and (meth)acrylic acid ester, or a saponified product thereof, a (meth)acrylic acid ester copolymer such as poly(meth)acrylic acid ester, (meth)acrylic acid butyl, and vinyl acetate, and a polyamide resin such as vinyl acetate copolymer nylon, copolymerization nylon, N-alkoxy methylated nylon, and N-dimethyl aminated nylon.

The thickness of the thermoplastic resin layer is preferably 6 μm to 100 μm, and is more preferably 6 μm to 50 μm. By setting the thickness of the thermoplastic resin layer to be in a range of 6 μm to 100 μm, even in a case where irregularity is generated on the substrate, it is possible to completely absorb the irregularity described above.

—Intermediate Layer—

The transfer material described above may include at least one intermediate layer in order to prevent components from being mixed at the time of performing coating of a plurality of coated layers and at the time of storing the coated layer after the coating. It is preferable that the intermediate layer described above is disposed between the temporary support described above and the colored layer described above (in a case of including the thermoplastic resin layer described above, between the thermoplastic resin layer described above and the colored layer described above). That is, it is preferable that the transfer material described above includes the temporary support described above, the thermoplastic resin layer described above, an intermediate layer, and the colored layer described above in this order.

It is preferable that an oxygen blocking film having an oxygen blocking function, which is disclosed in JP1993-72724A (JP-H05-72724A) as a “separation layer”, is used as the intermediate layer described above, and in this case, sensitivity at the time of performing exposure increases, a time load of an exposure machine is reduced, and productivity is improved.

An oxygen blocking film which exhibits low oxygen permeability and is dispersed or dissolved in water or an alkaline aqueous solution is preferable as the oxygen blocking film described above, and the oxygen blocking film is able to be suitably selected from known oxygen blocking films. Among them, a combination of polyvinyl alcohol and polyvinyl pyrrolidone is particularly preferable.

The thickness of the intermediate layer is preferably 0.1 μm to 5.0 μm, and is more preferably 0.5 μm to 2.0 μm. By setting the thickness of the intermediate layer to be in a range of 0.1 μm to 5.0 μm, oxygen blocking power does not decrease, and much time is not taken at the time of performing development or at the time of removing the intermediate layer.

—Protective Peeling Layer—

It is preferable that a protective peeling layer (also referred to as a cover film) is disposed in the transfer material described above to cover the colored layer described above in order to protect the colored layer from being contaminated or damaged at the time of being stored. The protective peeling layer described above may be formed of a material which is identical to or different from the material of the temporary support, and has to be easily separated from the colored layer described above. For example, silicone paper, and a polyolefin or polytetrafluoroethylene sheet are suitable as the material of the protective peeling layer described above.

The maximum value of the degree of haze of the protective peeling layer described above is preferably less than or equal to 3.0%, and the maximum value is preferably less than or equal to 2.5%, is more preferably less than or equal to 2.0%, and is particularly preferably less than or equal to 1.0%, from the viewpoint of effectively suppressing the occurrence of a void after developing the colored layer described above.

The thickness of the protective peeling layer described above is preferably 1 μm to 100 μm, is more preferably 5 μm to 50 μm, and is particularly preferably 10 μm to 30 μm. In a case where the thickness is greater than or equal to 1 μm, the strength of the protective peeling layer described above becomes sufficient, and thus, the protective peeling layer described above is rarely broken at the time of bonding the cover film to a photosensitive resin layer. In a case where the thickness is less than or equal to 100 μm, the price of the protective peeling layer described above does not increase, and a wrinkle rarely occurs at the time of laminating the protective peeling layer described above.

Such a protective peeling layer is a commercially available product, and examples of the commercially available product include ALPHAN MA-410, ALPHAN E-200C, and ALPHAN E-501, manufactured by Oji Paper Co., Ltd., a polypropylene film manufactured by Shin-Etsu Film Co., Ltd. or the like, a polyethylene terephthalate film such as PS series, for example, PS-25 or the like, manufactured by TEIJIN LIMITED., and the like, but are not limited thereto. In addition, it is possible to simply manufacture the protective peeling layer by performing sand blast processing with respect to a commercially available film.

A polyolefin film such as a polyethylene film is able to be used as the protective peeling layer described above. In addition, in general, a polyolefin film which is used as the protective peeling layer described above is manufactured by a thermally melting, kneading, extruding, biaxial stretching, and casting or inflating a raw material.

As described above, the film transfer material which is able to be used in the present invention has been described, the film transfer material described above may be a negative material or a positive material, as necessary.

—Manufacturing Method of Film Transfer Material—

A manufacturing method of the film transfer material as described above is not particularly limited, and for example, the film transfer material is able to be manufactured by a step disclosed in paragraphs 0064 to 0066 of JP2005-3861A. In addition, the film transfer material, for example, is able to be prepared by a method disclosed in JP2009-116078A.

Examples of the manufacturing method of the film transfer material include a method including a step of applying a resin composition onto a temporary support, drying the resin composition, and forming a colored layer, and a step of covering the formed colored layer described above with the protective peeling layer described above.

Here, the film transfer material which is able to be used in the present invention may form at least two layers of the white colored layer described above and the light shielding layer described above as a colored layer, and in a case where a film transfer material including a temporary support and a white colored layer is transferred onto a substrate, and then, the temporary support described above is removed, and a film transfer material including at least a temporary support and a light shielding layer is transferred onto the white colored layer described above, at least one layer of the white colored layer described above or the light shielding layer described above may be formed as the colored layer. In the former case, in (the transfer material) of the present invention, a transfer material in which the white colored layer described above and the light shielding layer described above are laminated on a temporary support in this order may be used, and in this case, it is preferable that the white decorative material and the light shielding material are able to be disposed on a (glass) substrate at one time from the viewpoint of a process.

In the film transfer material which is able to be used in the present invention, other layers may be further formed unless contrary to the gist of the present invention. In addition, a thermoplastic resin layer and/or an intermediate layer (an oxygen blocking layer) may be formed by coating before the colored layer is formed.

A known coating method is able to be used as a method of applying the composition for forming a colored layer described above, a coating liquid for forming the thermoplastic resin layer described above, and a coating liquid for forming the intermediate layer described above onto a temporary support. For example, the layers are able to be formed by applying the coating liquids using a coating machine such as a spinner, a wheeler, a roller coater, a curtain coater, a knife coater, a wire bar coater, and an extruder, and by drying the coating liquids.

—Solvent—

A coloration photosensitive composition for forming a colored layer of the film transfer material described above is able to be preferably prepared by using a solvent along with each component contained in the coloration photosensitive composition.

Examples of the solvent include esters, for example, ethyl acetate, n-butyl acetate, isobutyl acetate, amyl formate, isoamyl acetate, isobutyl acetate, butyl propionate, isopropyl butyrate, ethyl butyrate, and butyl butyrate, alkyl esters, methyl lactate, ethyl lactate, methyl oxy acetate, ethyl oxy acetate, butyl oxy acetate, methyl methoxy acetate, ethyl methoxy acetate, butyl methoxy acetate, methyl ethoxy acetate, ethyl ethoxy acetate, alkyl 3-oxy propionic acid esters such as methyl 3-oxy propionate and ethyl 3-oxy propionate (for example, methyl 3-methoxy propionate, ethyl 3-methoxy propionate, methyl 3-ethoxy propionate, and ethyl 3-ethoxy propionate), alkyl 2-oxy propionic acid esters such as methyl 2-oxy propionate, ethyl 2-oxy propionate, and propyl 2-oxy propionate (for example, methyl 2-methoxy propionate, ethyl 2-methoxy propionate, propyl 2-methoxy propionate, methyl 2-ethoxy propionate, ethyl 2-ethoxy propionate, methyl 2-oxy-2-methyl propionate, ethyl 2-oxy-2-methyl propionate, methyl 2-methoxy-2-methyl propionate, and ethyl 2-ethoxy-2-methyl propionate), methyl pyruvate, ethyl pyruvate, propyl pyruvate, methyl acetoacetate, ethyl acetoacetate, methyl 2-oxobutanoate, ethyl 2-oxobutanoate, and the like;

ethers, for example, diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol monomethyl ether acetate, propylene glycol monoethyl ether acetate, propylene glycol propyl ether acetate, and the like;

ketones, for example, methyl ethyl ketone, methyl isobutyl ketone, cyclohexanone, 2-heptanone, 3-heptanone, and the like;

aromatic hydrocarbons, for example, toluene, xylene; and the like.

Among them, the methyl ethyl ketone, the methyl isobutyl ketone, the xylene, the cyclohexanone, the propylene glycol monomethyl ether, the propylene glycol monomethyl ether acetate, and the like are preferable.

Only one type of the solvent may be independently used, or two or more types thereof may be used in combination.

A method of covering the colored layer described above with the protective peeling layer described above is not particularly limited, and a method of superposing the protective peeling layer described above on the colored layer on the temporary support, and of pressure bonding the protective peeling layer and the colored layer to each other is able to be used.

A known laminator such as a laminator, a vacuum laminator, and an automatic cutting laminator which is able to further increase productivity is able to be used in the pressure bonding.

It is preferable that an atmospheric temperature is 20° C. to 45° C., and a line pressure is 1,000 N/m to 10,000 N/m as the conditions of the pressure bonding described above.

—Lamination Method—

The colored layer described above is transferred (bonded) onto the surface of the substrate described above by superposing the colored layer on the surface of the substrate, and by pressurizing and heating the colored layer and the substrate. A known laminator such as a laminator, a vacuum laminator, and an automatic cutting laminator which is able to further increase productivity is able to be used in the bonding.

A sheet type method of transferring a punched decorative material onto a substrate in which air bubbles do not enter between the substrate and the decorative material with high accuracy is preferable as a lamination method from the viewpoint of increasing a yield.

Specifically, examples of the lamination method are able to preferably include a method using a vacuum laminator.

Examples of a device which is used in (continuous/sheet type) lamination are able to include V-SE340aaH manufactured by CLIMB PRODUCTS CO., LTD, and the like.

Examples of a vacuum laminator device are able to include a vacuum laminator device manufactured by Takanoseiki Corporation., FVJ-540R and FV700 manufactured by Taisei Laminator Co., LTD., and the like.

By including a step of further laminating a support on the temporary support described above on a side opposite to the coloring agent described above before the film transfer material described above is bonded to the substrate described above, it is possible to obtain a preferred effect in which the air bubbles do not enter at the time of performing lamination. At this time, the support to be used is not particularly limited, and examples of the support are able to include the followings.

Examples of the support are able to include polyethylene terephthalate, polycarbonate, triacetyl cellulose, and a cycloolefin polymer.

In addition, the film thickness is able to be selected in a range of 50 μm to 200 μm.

—Step of Removing Temporary Support—

It is preferable that a manufacturing method of the film transfer material described above include a step of removing the temporary support described above from the transfer material described above bonded to the substrate described above.

—Step of Removing Thermoplastic Resin Layer and Step of Removing Intermediate Layer—

Further, in a case where the film transfer material described above includes a thermoplastic resin layer or an intermediate layer, it is preferable to include a step of removing the thermoplastic resin layer and the intermediate layer.

In general, the step of removing the thermoplastic resin layer and the intermediate layer described above is able to be performed by using an alkaline developer which is used in a photolithography system. The alkaline developer described above is not particularly limited, and a known developer such as a developer disclosed in JP1993-72724A (JP-H05-72724A) is able to be used. Furthermore, it is preferable that the developer allows the decorative material to have a soluble development behavior, and for example, it is preferable that a compound having pKa of 7 to 13 is contained at a concentration of 0.05 mol/L to 5 mol/L, and a water miscible organic solvent may be added in a small amount. Examples of the water miscible organic solvent are able to include methanol, ethanol, 2-propanol, 1-propanol, butanol, diacetone alcohol, ethylene glycol monomethyl ether, ethylene glycol monoethyl ether, ethylene glycol mono-n-butyl ether, benzyl alcohol, acetone, methyl ethyl ketone, cyclohexanone, ε-caprolactone, γ-butyrolactone, dimethyl formamide, dimethyl acetamide, hexamethyl phosphor amide, ethyl lactate, methyl lactate, ε-caprolactam, N-methyl pyrrolidone, and the like. It is preferable that the concentration of the organic solvent described above is 0.1 mass % to 30 mass %.

In addition, a known surfactant is able to be further added to the alkaline developer described above. It is preferable that the concentration of the surfactant is 0.01 mass % to 10 mass %.

A method of performing the step of removing the thermoplastic resin layer and the intermediate layer described above may be any one of paddling, shower, shower & spinning, dipping, and the like. Here, in the shower described above, the thermoplastic resin layer or the intermediate layer is able to be removed by spraying the developer using the shower. In addition, it is preferable that a washing agent or the like is sprayed by the shower after the development, and the residue is removed while being wiped with a brush or the like. It is preferable that a liquid temperature is 20° C. to 40° C., and it is preferable that pH is 8 to 13.

—Postbaking Step—

It is preferable that a postbaking step is included after the transfer step described above, and it is more preferable that the postbaking step is included after the step of removing the thermoplastic resin layer and the intermediate layer described above.

In the manufacturing method of the film transfer material described above, it is preferable that the white colored layer described above and the light shielding layer described above of the film transfer material are able to be formed by being heated at 50° C. to 300° C. under an environment of 0.08 atm to 1.2 atm from the viewpoint of making whiteness and productivity compatible.

In addition, the inner edge of the decorative material of the present invention includes the tilt portion formed such that the thickness of the decorative material described above becomes thin towards the inside of the light transmitting region described above, and it is preferable that the tilt portion described above is formed by contracting the light shielding layer by heating. For example, in the postbaking step, the light shielding layer is contracted by heating the decorative material at 50° C. to 300° C., and thus, the tilt portion is able to be formed.

It is more preferable that the heating in the postbaking described above is performed under an environment of higher than or equal to 0.5 atm. On the other hand, it is more preferable that the heating is performed under an environment of higher than or equal to 1.1 atm, and it is particularly preferable that the heating is performed under an environment of higher than or equal to 1.0 atm. Further, it is more particularly preferable that the heating is performed under an environment of approximately 1 atm (an atmospheric pressure) from the viewpoint of reducing manufacturing costs without using a special reduced pressure device. Here, in the related art, in a case where the white colored layer described above and the light shielding layer described above are formed by being heated and cured, the whiteness after performing the baking is maintained by decreasing the oxygen concentration under a reduced pressure environment of an extremely low pressure, but by using the film transfer material described above, it is possible to improve the tint (decrease the b value) on the substrate side described above of the white colored layer described above and the light shielding layer described above of the substrate attached with a decorative material of the present invention, and to increase the whiteness even after the baking is performed in the range of the pressure described above.

The temperature of the postbaking described above is preferably 50° C. to 300° C., is more preferably 100° C. to 300° C., and is more preferably 120° C. to 300° C.

In addition, the postbaking described above may be performed at each of two or more different temperatures for a predetermined time. For example, first, heating is performed at 50° C. to 200° C., preferably at 100° C. to 200° C., and then, heating is able to be performed at 200° C. to 280° C., preferably at 220° C. to 260° C.

A time for performing the postbaking described above is more preferably 20 minutes to 150 minutes, and is particularly preferably 30 minutes to 100 minutes. In a case where the heating is performed at two or more temperature stages, and it is preferable that the total time for performing heating at each temperature stage is 20 minutes to 150 minutes.

The postbaking described above may be performed under an air environment, or may be performed under a nitrogen-substituted environment, and it is particularly preferable that the postbaking is performed under an air environment from the viewpoint of reducing the manufacturing costs without using a special reduced pressure device.

—Other Steps—

The manufacturing method of the film transfer material described above may include other steps such as a postexposure step.

In a case where the colored layer described above contains a photocurable resin, it is preferable that the postexposure step is included at the time of forming the white colored layer described above and the light shielding layer described above. The postexposure step described above may be performed only in a surface direction on a side in contact with the substrate described above of the white colored layer described above and the light shielding layer described above, may be performed only in a surface direction on a side not in contact with the transparent substrate described above, or may be performed in both surface directions.

Furthermore, a method disclosed in paragraphs 0035 to 0051 of JP2006-23696A is able to be preferably used in the present invention as an example of the exposure step described above, the development step, the step of removing the thermoplastic resin layer described above and the intermediate layer described above, and the other step.

(Thermal Transfer Printing)

In the thermal transfer printing described above, it is preferable that the white colored layer described above and the light shielding layer described above are respectively prepared by the thermal transfer printing of heating the temporary support side described above of the thermal transfer material including at least one of the white colored layer or the light shielding layer on the temporary support, and of transferring at least one of the white colored layer described above or the light shielding layer described above from the temporary support described above, and both of the white colored layer described above and the light shielding layer described above included in the thermal transfer material described above contain a resin having a siloxane bond in a main chain. Ink ribbon printing is preferable as a method of performing the thermal transfer printing described above. Examples of a method of performing the ink ribbon printing which is used in the manufacturing method of the substrate attached with a decorative material of the present invention are able to include a method disclosed in “Nonimpact Printing—Technology and Material—(published by CMC Publishing Co., Ltd., Dec. 1, 1986)” or the like.

(Screen Printing)

In the screen printing described above, it is preferable that the white colored layer described above and the light shielding layer described above are prepared by the screen printing of the composition for forming a white colored layer or the composition for forming a light shielding layer, and both of the composition for forming a white colored layer described above and the composition for forming a light shielding layer described above contain a resin having a siloxane bond in a main chain. A method of performing the screen printing described above is not particularly limited, and a known method is able to be used, and for example, a method disclosed in JP4021925B, or the like is able to be used. In addition, by performing the screen printing a plurality of times, it is possible to make the film thickness thick even in the screen printing.

(Ink Jet Printing)

In the ink jet printing described above, it is preferable that the white colored layer described above and the light shielding layer described above are prepared by the ink jet printing of the composition for forming a white colored layer or the composition for forming a light shielding layer, and both of the composition for a white colored layer described above and the composition for forming a light shielding layer described above contain a resin having a siloxane bond in a main chain. Examples of a method of performing the ink jet printing which is used in the manufacturing method of the substrate attached with a decorative material of the present invention are able to include a method disclosed in “Electronics Application of Ink Jet Technology (published by REALIZE Science & Engineering, Sep. 29, 2006)” or the like.

[Touch Panel]

The touch panel of the present invention includes the substrate attached with a decorative material of the present invention.

It is preferable that such a touch panel is an electrostatic capacitance type input device.

<<Electrostatic Capacitance Type Input Device, and Image Display Device Including Electrostatic Capacitance Type Input Device as Constituent>>

It is preferable that the electrostatic capacitance type input device described above includes a front plate (also referred to as a substrate), and at least the following elements (1) to (4) on a non-contact side of the front plate described above, and includes the substrate attached with a decorative material of the present invention as a laminated body of the front plate (the substrate) described above and (1) a decorative material including a light shielding layer and a white colored layer.

(1) A decorative material including a light shielding layer and a white colored layer

(2) A plurality of first transparent electrode patterns which are formed by allowing a plurality of pad portions to extend in a first direction through a connection portion

(3) A plurality of second electrode patterns which are electrically insulated from the first transparent electrode pattern described above, and are formed of a plurality of pad portions formed by extending in a direction intersecting with the first direction described above

(4) An insulating layer electrically insulating the first transparent electrode pattern described above from the second electrode pattern described above

In addition, in the electrostatic capacitance type input device described above, the second electrode pattern may be a transparent electrode pattern.

Further, the electrostatic capacitance type input device described above may further includes the following element (5).

(5) A conductive element which is electrically connected to at least one of the first transparent electrode pattern described above or the second transparent electrode pattern described above, and is different from the first transparent electrode pattern described above and the second transparent electrode pattern described above

Further, it is preferable that the electrostatic capacitance type input device described above includes the front plate (the substrate) described above, and (1) the decorative material including the light shielding layer and the white colored layer, and includes the substrate attached with a decorative material of the present invention as a laminated body including at least one electrode pattern of the elements (2), (3), or (5) described above as the conductive layer described above.

<Configuration of Electrostatic Capacitance Type Input Device>

First, the configuration of the electrostatic capacitance type input device to be formed by the manufacturing method of the present invention will be described. FIG. 5 and FIG. 6 are sectional views illustrating a preferred configuration of the electrostatic capacitance type input device of the present invention. In FIG. 5, an electrostatic capacitance type input device 10 is configured of a front plate 1b (cover glass), the white colored layer 2a, the light shielding layer 2b, a first transparent electrode pattern 3, a second transparent electrode pattern 4, an insulating layer 5, a conductive element 6, and a transparent protective layer 7. The tilt portion 2c is disposed in the white colored layer 2a, and the white colored layer 2a is formed such that the thickness becomes thin towards the inside of the electrostatic capacitance type input device 10.

It is preferable that the front plate 1 and/or the front plate 1b are configured of a light transmitting substrate. Any one of a light transmitting substrate in which a decorative material described below is disposed on the cover glass 1b, or a light transmitting substrate in which the decorative material described below is disposed on a film substrate in the order of the cover glass 1b and the film substrate 1 is able to be used as the light transmitting substrate. A case where the decorative material is disposed on the cover glass is preferable from the viewpoint of thinning the touch panel, and a case where the decorative material is disposed on the film substrate, and the film substrate is bonded to the cover glass is preferable from the viewpoint of the productivity of the touch panel.

In addition, the cover glass 1b is further disposed on a side of the film substrate opposite to the electrode. Reinforced glass or the like which is represented by GORILLA GLASS manufactured by Corning Incorporated is able to be used as the glass substrate. In addition, in FIG. 5 and FIG. 6, a side of the front plate 1 and/or the front plate 1b on which each element is disposed will be referred to as a non-contact surface 1a. In the electrostatic capacitance type input device 10 of the present invention, input is performed by bringing a finger or the like into contact with a contact surface (1a: a surface on a side opposite to the non-contact surface) of the front plate 1 and/or the front plate 1b. Hereinafter, the front plate may referred to as a “substrate”.

In addition, the white colored layer 2a and the light shielding layer 2b are disposed on the non-contact surface of the front plate 1 and/or the front plate 1b. The white colored layer 2a and the light shielding layer 2b as the decorative material are frame-like patterns around a light transmitting region (a display region) formed on the non-contact side of the front plate of the touch panel, and are formed such that routing wiring or the like is not observed or decoration is performed.

In the electrostatic capacitance type input device 10 of the present invention, a wiring taking out port (not illustrated) is able to be disposed. In a case where a substrate attached with a decorative material of an electrostatic capacitance type input device including a wiring taking out portion is formed, and a decorative material 2 is formed by using a liquid resist for forming a decorative material or screen printing ink, the leakage of a resist component from the wiring taking out portion or the bleed out of a resist component from a glass end of the decorative material occurs, and thus, a problem occurs in which a substrate back side is contaminated, but in a case where the substrate attached with a decorative material including the wiring taking out portion is used, such a problem is also able to be solved.

A plurality of first transparent electrode patterns 3 formed by allowing a plurality of pad portions to extend in the first direction through the connection portion, a plurality of second transparent electrode patterns 4 which are electrically insulated from the first transparent electrode pattern 3, and are formed of a plurality of pad portions formed by extending in the direction intersecting with the first direction, and the insulating layer 5 electrically insulating the first transparent electrode pattern 3 from the second transparent electrode pattern 4 are formed on the non-contact surface of the front plate 1 and/or the front plate 1b. The first transparent electrode pattern 3 described above, the second transparent electrode pattern 4 described above, and a conductive element 6 described below, for example, are able to be preferable by a conductive metal oxide film having light transmittance, such as indium tin oxide (ITO) or indium zinc oxide (IZO). Examples of such a metal film include an ITO film; a metal film such as Al, Zn, Cu, Fe, Ni, Cr, and Mo; an metal oxide film such as SiO₂, and the like. At this time, it is possible to set the film thickness of each element to 10 nm to 200 nm. In addition, an amorphous ITO film is formed into a polycrystalline ITO film by calcination, and thus, it is possible to reduce electrical resistance. In addition, the first transparent electrode pattern 3 described above, the second transparent electrode pattern 4 described above, and the conductive element 6 described below are able to be manufactured by using a transfer film including a decorative material using the conductive fiber described above. In addition, in a case of forming the first conductive pattern or the like by using ITO or the like, it is possible to refer to paragraphs 0014 to 0016 or the like of JP4506785B.

In addition, at least one of the first transparent electrode pattern 3 or the second transparent electrode pattern 4 is able to be disposed over both regions of the non-contact surface of the front plate 1 and/or the front plate 1b and the surface of the light shielding layer 2b on a side opposite to the front plate 1 and/or the front plate 1b. In FIG. 5 and FIG. 6, it is illustrated that the second transparent electrode pattern 4 is disposed over both regions of the non-contact surface of the front plate 1 and/or the front plate 1b and the surface of the light shielding layer 2b on a side opposite to the front plate 1 and/or the front plate 1b, and the side surface of the white colored layer 2a described above is covered with the second transparent electrode pattern 4. Here, the width of the white colored layer 2a described above is able to be narrower than the width of the light shielding layer 2b described above, and in this case, at least one of the first transparent electrode pattern 3 or the second transparent electrode pattern 4 is able to be disposed over the region of the non-contact surface of the front plate 1 and/or the front plate 1b and the surface of the white colored layer described above 2a and the light shielding layer 2b on a side opposite to the front plate 1 and/or the front plate 1b. Thus, even in a case where a transfer film is laminated over the decorative material including the white colored layer described above 2a and the light shielding layer 2b which are required to have a constant thickness and the back surface of the front plate, it is possible to perform lamination in which bubbles are not generated on the partial boundary of the decorative material 2 in a simple step, by using a film transfer material (in particular, the film transfer material including the thermoplastic resin layer described above) without using expensive equipment such as a vacuum laminator.

The first transparent electrode pattern 3 and the second transparent electrode pattern 4 will be described by using FIG. 8. FIG. 8 is an explanatory diagram illustrating an example of the first transparent electrode pattern and the second transparent electrode pattern of the present invention. As illustrated in FIG. 8, the first transparent electrode pattern 3 is formed by allowing a pad portion 3a to extending in the first direction through a connection portion 3b. In addition, the second transparent electrode pattern 4 is electrically insulated from the first transparent electrode pattern 3 by the insulating layer 5, and is configured of a plurality of pad portions formed by extending in the direction intersecting with the first direction (the second direction in FIG. 8). Here, in a case where the first transparent electrode pattern 3 is formed, the pad portion 3a described above and the connection portion 3b described above may be integrally prepared, or only the connection portion 3b may be prepared, and the pad portion 3a and the second transparent electrode pattern 4 may be integrally prepared (patterned). In a case where the pad portion 3a and the second transparent electrode pattern 4 are integrally prepared (patterned), as illustrated in FIG. 8, each layer is formed such that a part of the connection portion 3b and a part of the pad portion 3a are connected to each other, and the first transparent electrode pattern 3 and the second transparent electrode pattern 4 are electrically insulated from each other by the insulating layer 5.

In FIG. 5 and FIG. 6, the conductive element 6 is disposed on the surface of the light shielding layer 2b on a side opposite to the front plate 1 and/or the front plate 1b. The conductive element 6 is electrically connected to at least one of the first transparent electrode pattern 3 or the second transparent electrode pattern 4, and is an element different from the first transparent electrode pattern 3 and the second transparent electrode pattern 4. In FIG. 5 and FIG. 6, it is illustrated that the conductive element 6 is connected to the second transparent electrode pattern 4.

In addition, in FIG. 5 and FIG. 6, the transparent protective layer 7 is disposed to cover each entire constituent. The transparent protective layer 7 may be configured to cover only a part of each constituent. The insulating layer 5 and the transparent protective layer 7 may be formed of the same material, or may be formed of different materials. A material having high surface hardness and high heat resistance is preferable as the material configuring the insulating layer 5 and the transparent protective layer 7, and a known photosensitive siloxane resin material, a known acrylic resin material, and the like are used.

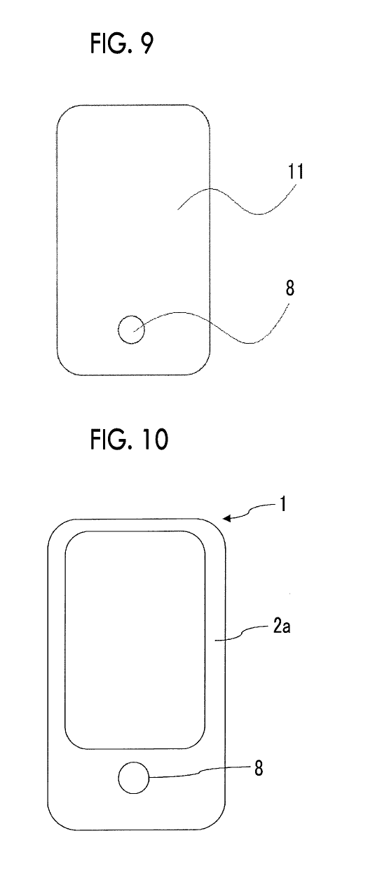

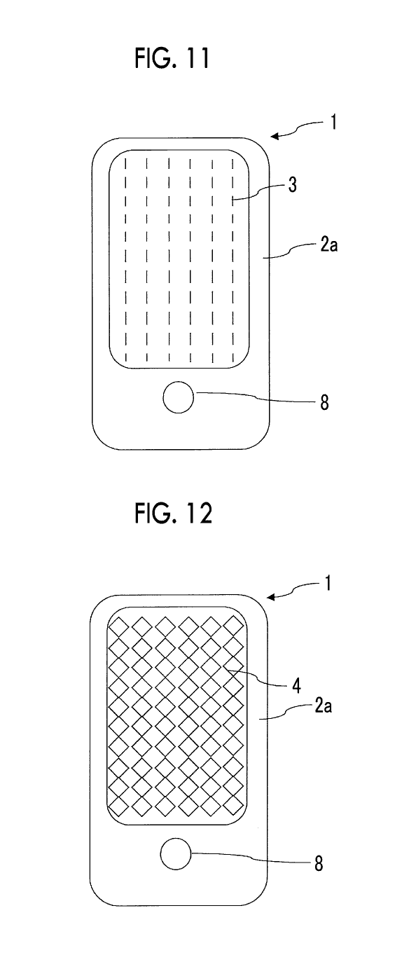

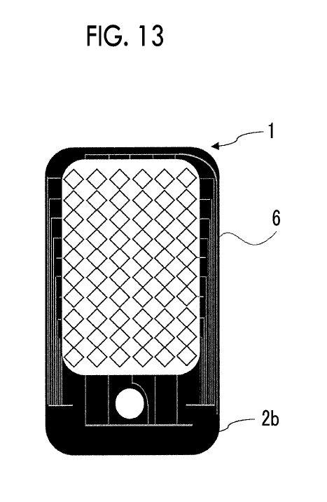

Examples of an embodiment formed in the process of the manufacturing method of the present invention are able to include embodiments of FIGS. 9 to 13. FIG. 9 is a top view illustrating an example of reinforced glass 11 on which the opening portion 8 is formed. FIG. 10 is a top view illustrating an example of a front plate on which the white colored layer 2a is formed. FIG. 11 is a top view illustrating an example of a front plate on which the first transparent electrode pattern 3 is formed. FIG. 12 is a top view illustrating an example of a front plate on which the second transparent electrode pattern 4 is formed. FIG. 13 is a top view illustrating an example of a front plate on which the conductive element 6 different from the first transparent electrode pattern and the second transparent electrode pattern is formed. These drawings illustrate examples in which the above description is specified, and the range of the present invention is not restrictively interpreted by the drawings.

Configurations disclosed in “Latest Touch Panel Technology” (published by Technotimes Co., Ltd. on Jul. 6, 2009), supervised by Yuji MITANI, “Technology and Development of Touch Panel”, published by CMC Publishing Co., Ltd. (December, 2004), FPD International 2009 Forum T-11 Presentation Textbook, Cypress Semiconductor Corporation Application Note AN2292, and the like are able to be applied to the electrostatic capacitance type input device described above, and an image display device including the electrostatic capacitance type input device described above as a constituent.

[Information Display Device]

An information display device of the present invention includes the touch panel of the present invention. It is effective that the touch panel of the present invention is used as an OGS type touch panel.

A mobile device is preferable as the information display device which is able to use the touch panel of the present invention, and examples of the mobile device are able to include an information display device described below.

Examples of the mobile device include iPhone 4 and iPad (Registered Trademark, manufactured by Apple Inc.), Xperia (SO-01B) (manufactured by Sony Mobile Communications Inc.), Galaxy S(SC-02B) and Galaxy Tab (SC-01C) (manufactured by Samsung Electronics), BlackBerry 8707h (manufactured by Research In Motion Limited), Kindle (manufactured by Amazon.com, Inc.), and Kobo Touch (manufactured by Rakuten, Inc.).

### EXAMPLES

Hereinafter, the characteristics of the present invention will be described in detail with reference to examples and comparative examples. Materials, use amounts, ratios, treatment contents, treatment sequences, and the like of the following examples are able to be suitably changed unless the changes cause deviance from the gist of the present invention. Therefore, the range of the present invention will not be restrictively interpreted by the following specific examples.

### Examples 1 to 20 and Comparative Examples 1 to 3

### Preparation of Black Coloring Liquid for Light Shielding Layer and White Coloring Liquid

Black coloring liquids 1 to 6 for a light shielding layer shown in the following table and white coloring liquids 1 to 16 shown in the following table were prepared by using the following materials. The numerical values in Table 1 and Table 2 indicate “part by mass”.

TABLE 1

| | Black | Black | Black | Black |
|---|---|---|---|---|
| | Coloring | Coloring | Coloring | Coloring |
| | Liquid 1 | Liquid 2 | Liquid 3 | Liquid 4 |
| Black Dispersion 1 | 240.0 | 240.0 | 240.0 | 240.0 |
| Silicone Resin Solution 1 | 130.2 | 127.5 | | |
| Silicone Resin Solution 2 | 108.5 | 106.2 | | |
| Silicone Resin Solution 3 | | | 255.0 | |
| Silicone Resin Solution 4 | | | | 637.4 |
| Polymerization Catalyst 1 | | 11.3 | 11.1 | 11.1 |
| Coating Auxiliary | 0.24 | 0.24 | 0.24 | 0.24 |
| Organic Solvent 1 | 269.1 | 269.1 | 247.9 | 56.7 |
| Organic Solvent 2 | 251.8 | 245.8 | 245.8 | 54.6 |
| Total | 999.84 | 1000.14 | 1000.04 | 1000.04 |

| | Black | B1ack |
|---|---|---|
| | Coloring | Coloring |
| | Liquid 5 | Liquid 6 |
| Black Dispersion 2 | 310.3 | |
| Black Dispersion 3 | | 310.3 |
| Silicone Resin Solution 1 | 120.4 | 120.4 |
| Silicone Resin Solution 2 | 100.3 | 100.3 |
| Polymerization Catalyst 1 | 11.1 | 11.1 |
| Coating Auxiliary | 0.2 | 0.2 |
| Organic Solvent 2 | 76.5 | 76.5 |
| Organic Solvent 3 | 382.6 | 382.6 |
| Total | 1001.4 | 1001.4 |

TABLE 2

| | White | White | White | White | White | White | White | White | White |
|---|---|---|---|---|---|---|---|---|---|
| | Coloring | Coloring | Coloring | Coloring | Coloring | Coloring | Coloring | Coloring | Coloring |
| | Liquid 1 | Liquid 2 | Liquid 3 | Liquid 4 | Liquid 5 | Liquid 6 | Liquid 7 | Liquid 8 | Liquid 9 |
| White | 167.1 | 167.1 | 167.1 | 167.1 | 167.1 | 167.1 | 167.1 | 167.1 | 167.1 |
| Dispersion 1 | | | | | | | | | |
| White | | | | | | | | | |
| Dispersion 2 | | | | | | | | | |
| White | | | | | | | | | |
| Dispersion 3 | | | | | | | | | |
| Silicone Resin | | | | | | | | | |
| Solution 1 | | | | | | | | | |
| Silicone Resin | | | | | | | | | |
| Solution 2 | | | | | | | | | |
| Silicone Resin | | | | | | | | | |
| Solution 3 | | | | | | | | | |
| Silicone Resin | 772.1 | 764.5 | 735.4 | 701.9 | 671.4 | 643.5 | 764.5 | 764.5 | 764.5 |
| Solution 4 | | | | | | | | | |
| Silicone Resin | 22.1 | 21.8 | 21.0 | 20.1 | 19.2 | 18.4 | 21.8 | 21.8 | 21.8 |
| Solution 5 | | | | | | | | | |
| Polymerization | | 7.0 | 33.6 | 64.2 | 92.1 | 117.7 | | | |
| Catalyst 1 | | | | | | | | | |
| Polymerization | | | | | | | 1.7 | | |
| Catalyst 2 | | | | | | | | | |
| Polymerization | | | | | | | | 1.7 | |
| Catalyst 3 | | | | | | | | | |
| Polymerization | | | | | | | | | 1.7 |
| Catalyst 4 | | | | | | | | | |
| Polymerization | | | | | | | | | |
| Catalyst 5 | | | | | | | | | |
| Antioxidant | 0.3 | 0.3 | 0.3 | 0.3 | 0.3 | 0.3 | 0.3 | 0.3 | 0.3 |
| Coating | 1.2 | 1.2 | 1.2 | 1.2 | 1.2 | 1.2 | 1.2 | 1.2 | 1.2 |
| Auxiliary | | | | | | | | | |
| Organic | 37.2 | 38.0 | 41.4 | 45.2 | 48.7 | 51.9 | 43.3 | 43.3 | 43.3 |
| Solvent 2 | | | | | | | | | |

| | White | White | White | White | White | White | White |
|---|---|---|---|---|---|---|---|
| | Coloring | Coloring | Coloring | Coloring | Coloring | Coloring | Coloring |
| | Liquid 10 | Liquid 11 | Liquid 12 | Liquid 13 | Liquid 14 | Liquid 15 | Liquid 16 |
| White | 167.1 | | 370.9 | 370.9 | 314.3 | 167.1 | |
| Dispersion 1 | | | | | | | |
| White | | 167.1 | | | | | |
| Dispersion 2 | | | | | | | |
| White | | | | | | | 195.0 |
| Dispersion 3 | | | | | | | |
| Silicone Resin | | | 187.8 | 313.0 | | | |
| Solution 1 | | | | | | | |
| Silicone Resin | | | 365.2 | 260.8 | | | |
| Solution 2 | | | | | | | |
| Silicone Resin | | | | | 530.5 | | |
| Solution 3 | | | | | | | |
| Silicone Resin | 764.5 | 764.5 | | | | 585.1 | 767.9 |
| Solution 4 | | | | | | | |
| Silicone Resin | 21.8 | 21.8 | | | | 16.7 | 21.9 |
| Solution 5 | | | | | | | |
| Polymerization | | | 12.5 | 12.5 | 10.6 | 181.9 | |
| Catalyst 1 | | | | | | | |
| Polymerization | | | | | | | |
| Catalyst 2 | | | | | | | |
| Polymerization | | | | | | | |
| Catalyst 3 | | | | | | | |
| Polymerization | | | | | | | |
| Catalyst 4 | | | | | | | |
| Polymerization | 1.7 | 1.7 | | | | | |
| Catalyst 5 | | | | | | | |
| Antioxidant | 0.3 | 0.3 | 0.6 | 0.6 | 0.5 | 0.3 | 0.3 |
| Coating | 1.2 | 1.2 | 2.4 | 2.4 | 2.0 | 1.2 | 1.2 |
| Auxiliary | | | | | | | |
| Organic | 43.3 | 43.3 | 60.7 | 39.9 | 142.1 | | 13.68 |
| Solvent 2 | | | | | | | |

Black Dispersion 1 (GC4151, manufactured by Sanyo Color Works, LTD.) (Carbon Black Concentration of 15%, and Concentration of Solid Contents of 20.7 mass %)

Black Dispersion 2

The following materials were mixed.

| | |
|---|---|
| Carbon Black (manufactured by Mitsubishi Chemical Corporation) | 15.0 g |
| Dispersing Agent A (a synthesis method will be described below) | 4.8 g |
| Xylene | 80.2 g |

Zirconia beads having a diameter of 0.5 mm were dispersed into a mixture by a bead mill for 3 hours, and thus, a black pigment dispersion was obtained.

Black Dispersion 3

The following materials were mixed.

| | |
|---|---|
| Carbon Black (manufactured by Mitsubishi | 15.0 g |
| Chemical Corporation) | |
| Dispersing Agent A (a synthesis method | 4.8 g |
| will be described below) | |
| Silicone Oil (X-22-4039, manufactured by Shin-Etsu | 3.0 g |
| Chemical Co., Ltd.) | |
| Xylene | 77.2 g |

Zirconia beads having a diameter of 0.5 mm were dispersed into a mixture by using a bead mill for 3 hours, and thus, a black pigment dispersion was obtained.

White Dispersion 1 (FP White B422, manufactured by Sanyo Color Works, LTD.) (Titanium Oxide Concentration of 70%, and Concentration of Solid Contents of 73.5 mass %)

White Dispersion 2

The following materials were mixed.

| | |
|---|---|
| Titanium Oxide (CR-97, manufactured by ISHIHARA | 70.0 g |
| SANGYO KAISHA, LTD.) | |
| Dispersing Agent (KP-578, manufactured by | 3.0 g |
| Shin-Etsu Chemical Co., Ltd.) | |
| Dispersion Binder (X-40-9246, manufactured by | 6.0 g |
| Shin-Etsu Chemical Co., Ltd.) | |
| Methyl Ethyl Ketone | 21.0 g |

Then, zirconia beads (a particle diameter of 0.5 mm) were added into a mixture, and a dispersion treatment was performed at 2000 rpm for 1 hour by using a bead mill (BSG-01, manufactured by IMEX Co., Ltd.), and thus, a white dispersion 2 was obtained.

White Dispersion 3

The following materials were mixed.

| | |
|---|---|
| Titanium Oxide (CR-97, manufactured by ISHIHARA | 60.0 g |
| SANGYO KAISHA, LTD.) | |
| Dispersing Agent A (a synthesis method will be described below) | 6.0 g |
| Xylene | 34.0 g |

Then, zirconia beads (a particle diameter of 0.5 mm) were added into a mixture, and a dispersion treatment was performed at 2000 rpm for 1 hour by using a bead mill (BSG-01, manufactured by IMEX Co., Ltd.), and thus, a white dispersion 3 was obtained.

[Synthesis of Dispersing Agent A] 45.8 parts of KF-2001 (manufactured by Shin-Etsu Chemical Co., Ltd.), 53.3 parts of KF-2012 (manufactured by Shin-Etsu Chemical Co., Ltd.), and 0.9 parts of a methacrylic acid were dissolved in 100 parts of xylene, and polymerization initiator (dimethyl-2,2′-azobis(2-methyl propionate), “V-601”) was dissolved at a ratio of 0.3 mol % with respect to the total of polymerization components, and polymerization was performed at 80° C. under a nitrogen atmosphere. In the middle of the process, a polymerization initiator (V-601) was added at a ratio of 0.3 mol % with respect to the total of polymerization components after 2 hours from the initiation of the polymerization, and polymerization was performed for 4 hours in total. A purification treatment and drying were performed after the polymerization, and thus, a dispersing agent A was obtained.

Silicone Resin Solution 1 (KR300, manufactured by Shin-Etsu Chemical Co., Ltd., Compositions Described below)

Xylene Solution of Silicone Resin (Solid Content of 50 mass %)

Silicone Resin Solution 2 (KR311, manufactured by Shin-Etsu Chemical Co., Ltd., Composition Described below)

Xylene Solution of Silicone Resin (Solid Content of 60 mass %)

Silicone Resin Solution 3 (KR255, manufactured by Shin-Etsu Chemical Co., Ltd., Composition Described below)

Xylene Solution of Silicone Resin (Solid Content of 50 mass %)

Silicone Resin Solution 4 (KR251, manufactured by Shin-Etsu Chemical Co., Ltd., Composition Described below)

Toluene Solution of Silicone Resin (Solid Content of 20 mass %)

Silicone Resin Solution 5 (X-40-9246, manufactured by Shin-Etsu Chemical Co., Ltd., Composition Described below)

Silicone Oligomer (Solid Content of 100 mass %)

Polymerization Catalyst 1 (D-15, manufactured by Shin-Etsu Chemical Co., Ltd., Composition Described below)

Xylene Solution of Zinc-Containing Catalyst (Solid Content of 25 mass %)

Polymerization Catalyst 2 (Iron (III) Triacetyl Acetonate)

Polymerization Catalyst 3 (Aluminum (III) Triacetyl Acetonate)

Polymerization Catalyst 4 (Dibutoxy Zirconium (IV) Diacetyl Acetonate)

Polymerization Catalyst 5 (Zirconium Octylate)

Antioxidant (IRGAFOS 168, manufactured by BASF SE, Composition Described below)

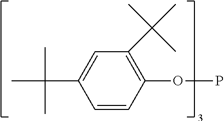

Coating Auxiliary (MEGAFAC F-780F, manufactured by DIC Corporation, Concentration of Solid Contents of 30 mass %)

Organic Solvent 1 (Cyclohexanone)

Organic Solvent 2 (Methyl Ethyl Ketone)

Organic Solvent 3 (Xylene)

<Preparation of Transfer Material for Forming Decorative Material>

<<Preparation of Peeling Film>>

The following peeling film was prepared as a temporary support attached with a peeling layer of a transfer material.

UNIPEEL TR6 (manufactured by UNITIKA LTD., an olefin-based peeling layer in which a matting agent protrudes from a peeling layer by 200 nm is provided on a PET film having a thickness of 75 μm)

<<Preparation of Protective Film>>

Next, a protective film described below was prepared.

ALPHAN E-501 (manufactured by Oji F-Tex Co., Ltd., a polypropylene film having a thickness of 12 μm)

<Preparation of Color Material Layer onto Temporary Support (Transfer Layer Formed of Light Shielding Layer and White Colored Layer)>

Any one of the black coloring liquids 1 to 6 for forming a light shielding layer shown in the following table was applied onto the peeling layer of the temporary support attached with a peeling layer by using an E type coating machine such that a dry thickness became 3.0 μm, and was dried.

Any one of the white coloring liquids 1 to 16 for forming a white colored layer shown in the following table was applied onto the light shielding layer such that a dry thickness became 35.0 μm, and was dried. The protective film described above was pressure-bonded onto the white colored layer.

Thus, transfer materials 1 to 24 formed of the light shielding layer and the white layer, shown in the following table, in which the temporary support, and the light shielding layer and the white colored layer were integrated with each other were prepared.

TABLE 3

| | | | Black Coloring | |
|---|---|---|---|---|
| | | | Liquid | White Coloring |
| | | | for Light | Liquid |
| | Transfer | Configuration of Transfer | Shielding | for White |
| | Material | Material | Layer | Colored Layer |
| Preparation | Transfer | Lamination of Light Shielding | Black Coloring | White Coloring |
| Example 1 | Material 1 | Layer and White Colored Layer | Liquid 2 | Liquid 1 |
| Preparation | Transfer | Lamination of Light Shielding | Black Coloring | White Coloring |
| Example 2 | Material 2 | Layer and White Colored Layer | Liquid 2 | Liquid 2 |
| Preparation | Transfer | Lamination of Light Shielding | Black Coloring | White Coloring |
| Example 3 | Material 3 | Layer and White Colored Layer | Liquid 2 | Liquid 3 |
| Preparation | Transfer | Lamination of Light Shielding | Black Coloring | White Coloring |
| Example 4 | Material 4 | Layer and White Colored Layer | Liquid 2 | Liquid 4 |
| Preparation | Transfer | Lamination of Light Shielding | Black Coloring | White Coloring |
| Example 5 | Material 5 | Layer and White Colored Layer | Liquid 2 | Liquid 5 |
| Preparation | Transfer | Lamination of Light Shielding | Black Coloring | White Coloring |
| Example 6 | Material 6 | Layer and White Colored Layer | Liquid 2 | Liquid 6 |
| Preparation | Transfer | Lamination of Light Shielding | Black Coloring | White Coloring |
| Example 7 | Material 7 | Layer and White Colored Layer | Liquid 2 | Liquid 7 |
| Preparation | Transfer | Lamination of Light Shielding | Black Coloring | White Coloring |
| Example 8 | Material 8 | Layer and White Colored Layer | Liquid 2 | Liquid 8 |
| Preparation | Transfer | Lamination of Light Shielding | Black Coloring | White Coloring |
| Example 9 | Material 9 | Layer and White Colored Layer | Liquid 2 | Liquid 9 |
| Preparation | Transfer | Lamination of Light Shielding | Black Coloring | White Coloring |
| Example 10 | Material 10 | Layer and White Colored Layer | Liquid 2 | Liquid 10 |
| Preparation | Transfer | Lamination of Light Shielding | Black Coloring | White Coloring |
| Example 11 | Material 11 | Layer and White Colored Layer | Liquid 2 | Liquid 11 |
| Preparation | Transfer | Lamination of Light Shielding | Black Coloring | White Coloring |
| Example 12 | Material 12 | Layer and White Colored Layer | Liquid 2 | Liquid 12 |
| Preparation | Transfer | Lamination of Light Shielding | Black Coloring | White Coloring |
| Example 13 | Material 13 | Layer and White Colored Layer | Liquid 2 | Liquid 13 |
| Preparation | Transfer | Lamination of Light Shielding | Black Coloring | White Coloring |
| Example 14 | Material 14 | Layer and White Colored Layer | Liquid 2 | Liquid 14 |
| Preparation | Transfer | Lamination of Light Shielding | Black Coloring | White Coloring |
| Example 15 | Material 15 | Layer and White Colored Layer | Liquid 1 | Liquid 2 |
| Preparation | Transfer | Lamination of Light Shielding | Black Coloring | White Coloring |
| Example 16 | Material 16 | Layer and White Colored Layer | Liquid 3 | Liquid 2 |
| Preparation | Transfer | Lamination of Light Shielding | Black Coloring | White Coloring |
| Example 17 | Material 17 | Layer and White Colored Layer | Liquid 4 | Liquid 2 |
| Preparation | Transfer | Lamination of Light Shielding | Black Coloring | White Coloring |
| Example 18 | Material 18 | Layer and White Colored Layer | Liquid 5 | Liquid 16 |
| Preparation | Transfer | Lamination of Light Shielding | Black Coloring | White Coloring |
| Example 19 | Material 19 | Layer and White Colored Layer | Liquid 6 | Liquid 16 |
| Preparation | Transfer | Lamination of Light Shielding | Black Coloring | White Coloring |
| Example 20 | Material 20 | Layer and White Colored Layer | Liquid 2 | Liquid 16 |
| Preparation | Transfer | Lamination of Light Shielding | Black Coloring | White Coloring |
| Example 21 | Material 21 | Layer and White Colored Layer | Liquid 5 | Liquid 2 |
| Preparation | Transfer | Lamination of Light Shielding | Black Coloring | White Coloring |
| Example 22 | Material 22 | Layer and White Colored Layer | Liquid 1 | Liquid 10 |
| Preparation | Transfer | Lamination of Light Shielding | Black Coloring | White Coloring |
| Example 23 | Material 23 | Layer and White Colored Layer | Liquid 1 | Liquid 11 |
| Preparation | Transfer | Lamination of Light Shielding | Black Coloring | White Coloring |
| Examnle 24 | Material 24 | Layer and White Colored Layer | Liquid 1 | Liquid 15 |

<Preparation of Substrate Attached with Decorative Material (Example 1)>

Reinforced glass (300 mm×400 mm×0.7 mm) on which an opening portion (15 mmΦ) was formed as illustrated in FIG. 7 was washed with a rotary brush including a nylon brush while spraying a glass washing agent liquid of which the temperature was adjusted to be 25° C. by a shower for 20 seconds. The glass substrate was preheated at 90° C. for 2 minutes in a substrate preheating device.

The transfer material 1 of Preparation Example 1, which was laminated with the light shielding layer and the white colored layer, was formed into the shape of a frame having a size corresponding to four sides of the glass substrate, and then, was transferred onto the glass substrate described above. After that, the temporary support of the transfer material 1 was peeled off. In order to cure the light shielding layer and the white colored layer, the obtained film was heated at 150° C. for 30 minutes along with a glass substrate (a substrate), and was further heated at 240° C. for 30 minutes. Accordingly, a substrate attached with a decorative material of Example 1 was obtained.

<Preparation of Substrate Attached with Decorative Material (Examples 2 to 20 and Comparative Examples 1 to 3)>

In Example 1, substrates attached with a decorative material of Examples 2 to 20 and Comparative Examples 1 to 3, in which the light shielding layer and/or the white colored layer was formed on the glass substrate, were obtained by the same method as that in Example 1 except that the white transfer material and the black transfer material which were used were changed as shown in the following table.

<Preparation of Substrate Attached with Decorative Material (Comparative Examples 4 and 5)>

As described below, substrates attached with a decorative material of Comparative Examples 4 and 5 were obtained by the same method as that in Example 1 except that the decorative material was formed by screen printing.

(Screen Printing Method)

The viscosity of the white coloring liquid 2 was adjusted to be 1,000 mPa·s by reducing the ratio of each organic solvent, and by performing concentration at room temperature in reduced pressure, and thus, a white coloring liquid 2a was prepared. Subsequently, the viscosity of the black coloring liquid 2 was adjusted to be 200 mPa·s by reducing the ratio of each organic solvent, and thus, a black coloring liquid 2a was prepared.

A white colored layer 2a having a thickness of 8 μm was prepared with the white coloring liquid 2a on the glass substrate by using a 225 mesh (an opening diameter of 65 μm) and a polyester screen having a gauze thickness of 72 μm. This process was repeated, and thus, a white colored layer 2a having a thickness of 32 μm was prepared. At this time, the screen printing was performed by adjusting the position of the white layer such that the end portion of the white layer was arranged at the time of laminating the white layer. The white colored layer 2a was heated at 150° C. for 30 minutes, and thus, was hardened. A light shielding layer 2a having a thickness of 3.0 μm was laminated on the white colored layer 2a by using the black coloring liquid 2a. At this time, the screen printing was performed by adjusting the position of the white layer and the light shielding layer such that the end portion of the white layer and the end portion of the light shielding layer was arranged. Thus, substrates attached with a decorative material of Comparative Examples 5 and 6 were obtained. As a result of visually observing the end portion of the white layer, it was confirmed that the linearity of the end portion of the white layer was insufficient, and a part of the light shielding layer bled out to a portion where the white layer did not exist.

Therefore, at the time of laminating the white layer and at the time of laminating the light shielding layer on the white layer, the position of the white layer and the light shielding layer was adjusted to sequentially recede by 200 μm from the end portion of the white layer close to the glass boundary surface. As a result of visually observing the end portion of the white layer, there was no problem in the linearity of the end portion of the white layer, and the bleed out of the light shielding layer was not observed.

<Evaluation>

An evaluation method of the properties of the substrate attached with a decorative material of each of the examples and the comparative examples obtained as described above will be described below. In addition, the obtained results were respectively shown in the following table.

(Measurement of Taper Tilt Angle)

A curve configuring the tilt surface of a tilt portion on the sectional surface of the obtained substrate attached with a decorative material was approximated to a straight line, and the straight line was set to a tilt angle θ.

(Measurement of Difference Between Width of White Colored Layer on Substrate Side and Width of Light Shielding Layer)

The substrate attached with a decorative material was observed from a side opposite to the substrate by using an optical microscope, and the length was measured.

(Appearance Evaluation)

In the obtained substrate attached with a decorative material, appearance evaluation was performed on the basis of the following criteria. In practice, an allowable level is A and B.

A: In a case where the substrate attached with a decorative material is visually observed from a side including the white colored layer, a positional difference between the end portion of the white colored layer and the end portion of the light shielding layer is not able to be observed, and even in a case where the substrate attached with a decorative material is visually observed from a side opposite to the side including the white colored layer, a portion having low transmission density is not able to be observed in the vicinity of the end portion of the white colored layer.

B: In a case where the substrate attached with a decorative material is visually observed from the side including the white colored layer, a positional difference between the end portion of the white colored layer and the end portion of the light shielding layer is able to be observed, but in a case where the substrate attached with a decorative material is visually observed from the side opposite to the side including the white colored layer, a portion having low transmission density is not able to be observed in the vicinity of the end portion of the white colored layer.

C: In a case where the substrate attached with a decorative material is visually observed from the side including the white colored layer, a positional difference between the end portion of the white colored layer and the end portion of the light shielding layer is able to be observed, and in a case where the substrate attached with a decorative material is visually observed from the side opposite to the side including the white colored layer, a portion having low transmission density is able to be observed in the vicinity of the end portion of the white colored layer.

D: A part of the light shielding layer bleeds out from the colored end portion of the white layer.

(ITO Conductivity)

A transparent electrode layer was formed in a portion including a taper tilt portion on the substrate attached with a decorative material by the following method, and evaluation was performed according to the number of disconnections thereof.

((Formation of Transparent Electrode Layer))

The substrate attached with a decorative material of each of the examples was introduced into a vacuum chamber, and an ITO thin film having a thickness of 40 nm was formed by DC magnetron sputtering (Conditions: Temperature of Substrate of 250° C., Argon Pressure of 0.13 Pa, and Oxygen Pressure of 0.01 Pa) using an ITO target (indium:tin=95:5 (Molar Ratio)) in which the content ratio of SnO₂ was 10 mass %, and thus, a front plate was obtained in which the transparent electrode layer was formed. The surface resistance of the ITO thin film was 80 Ω/□.

((Preparation of Transfer Film E1 for Etching))

A thermoplastic resin layer and an intermediate layer were formed on a temporary support by the following method.

A coating liquid for a thermoplastic resin layer formed of a formulation H1 described below was applied onto a polyethylene terephthalate film temporary support having a thickness of 75 μm by using a slit-like nozzle, and was dried. Next, a coating liquid for an intermediate layer formed of a formulation P1 described below was applied thereonto, and was dried.

—Coating Liquid for Thermoplastic Resin Layer: Formulation H1—
Methanol: 11.1 parts by mass
Propylene Glycol Monomethyl Ether Acetate: 6.36 parts by mass
Methyl Ethyl Ketone: 52.4 parts by mass
Methyl Methacrylate/2-Ethyl Hexyl Acrylate/Benzyl Methacrylate/Methacrylic Acid Copolymer (Copolymerization Compositional Ratio (Molar Ratio)=55/11.7/4.5/28.8, Molecular Weight=100,000, and Tg≅70° C.): 5.83 parts by mass
Styrene/Acrylic Acid Copolymer (Copolymerization Compositional Ratio (Molar Ratio)=63/37, Weight-Average Molecular Weight=10,000, and Tg≅100° C.): 13.6 parts by mass
Monomer 1 (Product Name: BPE-500, manufactured by Shin Nakamura Chemical Co., Ltd.): 9.1 parts by mass
Coating Auxiliary (MEGAFAC F-780F): 0.54 parts by mass

Furthermore, the viscosity of a coating liquid H1 for a thermoplastic resin layer at 120° C. after a solvent was removed therefrom was 1,500 Pa·sec.

—Coating Liquid for Intermediate Layer: Formulation P1—
Polyvinyl Alcohol: 32.2 parts by mass (Product Name: PVA205, manufactured by KURARAY CO., LTD., Degree of Saponification=88%, and Degree of Polymerization of 550)
Polyvinyl Pyrrolidone: 14.9 parts by mass (Product Name: K-30, manufactured by Ashland Japan Co., Ltd.)
Distilled Water: 524 parts by mass
Methanol: 429 parts by mass

(Preparation of Transfer Film E1 for Etching)

A coating liquid for a photocurable resin layer for etching formed of the formulation E1 described below was applied onto the substrate including the thermoplastic resin layer and the intermediate layer on the temporary support, and was dried. A protective film was pressure-bonded thereto, and thus, a transfer film E1 for etching was obtained in which the temporary support, the thermoplastic resin layer, the intermediate layer (an oxygen blocking film), the photocurable resin layer for etching, and the protective film for etching were integrated with each other (the film thickness of the photocurable resin layer for etching was 2.0 μm).

—Coating Liquid for Photocurable Resin Layer for Etching: Formulation E1—
Methyl Methacrylate/Styrene/Methacrylic Acid Copolymer (Copolymer Composition (Mass %): 31/40/29, Mass Average Molecular Weight of 60000, and Acid Value of 163 mgKOH/g): 16 parts by mass
Monomer 1 (Product Name: BPE-500, manufactured by Shin Nakamura Chemical Co., Ltd.): 5.6 parts by mass
Adduct of 0.5 moles of Tetraethylene Oxide Monomethacrylate of Hexamethylene Diisocyanate: 7 parts by mass
Cyclohexane Dimethanol Monoacrylate as Compound Having One Polymerizable Group In Molecules: 2.8 parts by mass
2-Chloro-N-Butyl Acridone: 0.42 parts by mass
2,2-Bis(o-Chlorophenyl)-4,4′,5,5′-Tetraphenyl Biimidazole: 2.17 parts by mass
Leuco Crystal Violet: 0.26 parts by mass
Phenothiazine: 0.013 parts by mass
Surfactant (Product Name: MEGAFAC F-780F, manufactured by DIC Corporation): 0.03 parts by mass
Methyl Ethyl Ketone: 40 parts by mass
1-Methoxy-2-Propanol: 20 parts by mass

(Formation of Transparent Electrode Pattern)

The front plate in which the white colored layer, the light shielding layer, and the transparent electrode layer were formed was washed, and the transfer film E1 for etching from which the protective film was removed was laminated thereon (Substrate Temperature: 130° C., Rubber Roller Temperature of 120° C., Line Pressure of 100 N/cm, and Transport Speed of 2.2 m/minute). The temporary support was peeled off, and then, a distance between the surface of an exposure mask (a quartz exposure mask having a transparent electrode pattern) and the photocurable resin layer for etching described above was set to 200 μm, and pattern exposure was performed at an exposure amount of 50 mJ/cm² (an i line) into the shape of a stripe in which a line width was 40 μm, and the number of lines was 20.

Next, the front plate attached with a transparent electrode layer pattern including a photocurable resin layer pattern for etching was dipped in a resist peeling bath into which a resist peeling liquid (N-methyl-2-pyrrolidone, monoethanol amine, a surfactant (Product Name: SURFYNOL 465, manufactured by Air Products and Chemicals, Inc.), and a liquid temperature of 45° C.) was put, and was treated for 200 seconds, and the photocurable resin layer for etching was removed, and thus, a front plate was obtained in which the white colored layer, the light shielding layer, and 20 stripe-like transparent electrode patterns disposed over both regions of the non-contact surface of the front plate described above and the surface of the light shielding layer described above on a side opposite to the front plate described above as illustrated in FIG. 5 were formed. In the transparent electrode pattern formed on the light shielding layer of the substrate attached with a decorative material of each of the examples and the comparative examples prepared as described above, the occurrence of the disconnection was measured by prober inspection, and evaluation was performed on the basis of the following criteria.

A: In the prepared 20 transparent electrode patterns, no disconnection was confirmed.

B: In the prepared 20 transparent electrode patterns, the disconnection was confirmed in several patterns.

C: In the prepared 20 transparent electrode patterns, the disconnection was confirmed in a half or more of the patterns.

TABLE 4

| | | Tilt | Difference | Appear- | ITO |
|---|---|---|---|---|---|
| | | Angle | in | ance | Con- |
| | | (De- | Width | Eval- | duc- |
| | Transfer Material | grees) | (μm) | uation | tivity |
| Example 1 | Preparation Example 1 | 15 | 115 | B | A |
| Example 2 | Preparation Example 2 | 25 | 65 | B | A |
| Example 3 | Preparation Example 3 | 33 | 48 | B | A |
| Example 4 | Preparation Example 4 | 42 | 30 | A | A |
| Example 5 | Preparation Example 5 | 52 | 25 | A | A |
| Comparative | Preparation Example 6 | 61 | 16 | A | B |
| Example 1 | | | | | |
| Example 6 | Preparation Example 7 | 29 | 58 | B | A |
| Example 7 | Preparation Example 8 | 28 | 56 | B | A |
| Example 8 | Preparation Example 9 | 23 | 73 | B | A |
| Example 9 | Preparation Example 10 | 35 | 44 | B | A |
| Example 10 | Preparation Example 11 | 25 | 69 | B | A |
| Example 11 | Preparation Example 12 | 10 | 180 | B | A |
| Example 12 | Preparation Example 13 | 15 | 115 | B | A |
| Example 13 | Preparation Example 14 | 23 | 75 | B | A |
| Example 14 | Preparation Example 15 | 27 | 53 | B | A |
| Example 15 | Preparation Example 16 | 31 | 52 | B | A |
| Example 16 | Preparation Example 17 | 32 | 46 | B | A |
| Example 17 | Preparation Example 18 | 25 | 68 | A | A |
| Example 18 | Preparation Example 19 | 30 | 62 | A | A |
| Example 19 | Preparation Example 20 | 22 | 70 | A | A |
| Example 20 | Preparation Example 21 | 24 | 70 | A | A |
| Comparative | Preparation Example 22 | 6 | 290 | C | A |
| Example 1 | | | | | |
| Comparative | Preparation Example 23 | 8 | 210 | C | A |
| Example 2 | | | | | |
| Comparative | Preparation Example 24 | 80 | 5 | A | C |
| Example 3 | | | | | |
| Comparative | Screen Printing Method | 8 | 202 | D | A |
| Example 4 | | | | | |
| Comparative | Screen Printing Method | 6 | 280 | C | A |
| Example 5 | | | | | |

From the following table, the substrates attached with a decorative material prepared in Examples 1 to 20 had a good appearance and excellent ITO conductivity since the bleed out of the light shielding layer from the end portion of the white layer and a region having low transmission density were not confirmed, and thus, the substrates attached with a decorative material were preferable as a white decorative material for a front plate integrated touch panel.

In contrast, in a case where a taper tilt angle degree was greater than 80 degrees (Comparative Example 3), there was no problem in the appearance, but a part of ITO was disconnected, and thus, the substrate attached with a decorative material was not preferable as a white decorative material for a front plate integrated touch panel. In addition, in a case where the taper tilt angle degree was less than 10 degrees (Comparative Examples 1, 2, 4, and 5), there was a problem in the appearance, and thus, the substrates attached with a decorative material were not preferable as a white decorative material for a front plate integrated touch panel.

### Example 101

### Preparation of Touch Panel

Formation of First Transparent Electrode Pattern

(Formation of Transparent Electrode Layer)

The substrate attached with a decorative material of each of the examples was introduced into a vacuum chamber, and an ITO thin film having a thickness of 40 nm was formed by DC magnetron sputtering (Conditions: Temperature of Substrate of 250° C., Argon Pressure of 0.13 Pa, and Oxygen Pressure of 0.01 Pa) using an ITO target (indium:tin=95:5 (Molar Ratio)) in which the content ratio of SnO₂ was 10 mass %, and thus, a front plate was obtained in which the transparent electrode layer was formed. The surface resistance of the ITO thin film was 80Ω/□.

(Formation of First Transparent Electrode Pattern)

The front plate in which the white colored layer, the light shielding layer, and the transparent electrode layer were formed was washed, and the transfer film E1 for etching from which the protective film was removed was laminated thereon (Substrate Temperature: 130° C., Rubber Roller Temperature of 120° C., Line Pressure of 100 N/cm, and Transport Speed of 2.2 m/minute). The temporary support was peeled off, and then, a distance between the surface of an exposure mask (a quartz exposure mask having a transparent electrode pattern) and the photocurable resin layer for etching described above was set to 200 μm, and pattern exposure was performed at an exposure amount of 50 mJ/cm² (an i line).

Next, a treatment was performed at 25° C. for 100 seconds by using a triethanol amine-based developer (a liquid in which T-PD2 (Product Name, manufactured by Fujifilm Corporation) containing 30 mass % of triethanol amine was diluted 10 times with pure water), a treatment was performed at 33° C. for 20 seconds by using a surfactant-containing washing liquid (a liquid in which T-SD3 (Product Name, manufactured by Fujifilm Corporation) was diluted 10 times with pure water), and the residue in the thermoplastic resin layer and the intermediate layer was removed by a rotary brush and an ultra high pressure washing nozzle, and a postbaking treatment was further performed at 130° C. for 30 minutes, and thus, a front plate was obtained in which the white colored layer, the light shielding layer, the transparent electrode layer, and the photocurable resin layer pattern for etching were formed.

The front plate in which the white colored layer, the light shielding layer, the transparent electrode layer, and the photocurable resin layer pattern for etching were formed was dipped in an etching bath into which an ITO echant (a hydrochloric acid, an aqueous solution of potassium chloride, and a liquid temperature of 30° C.) was put, a treatment was performed for 100 seconds, and the transparent electrode layer in an exposed region which was not covered with the photocurable resin layer for etching was removed by being dissolved, and thus, a front plate attached with a white layer, a light shielding layer, and a transparent electrode layer pattern including a photocurable resin layer pattern for etching was obtained.

Next, the front plate attached with a transparent electrode layer pattern including the photocurable resin layer pattern for etching was dipped in a resist peeling bath into which a resist peeling liquid (N-methyl-2-pyrrolidone, monoethanol amine, a surfactant (Product Name: SURFYNOL 465, manufactured by Air Products and Chemicals, Inc.), and a liquid temperature of 45° C.) was put, a treatment was performed for 200 seconds, and the photocurable resin layer for etching was removed, and thus, a front plate was obtained in which the white colored layer, the light shielding layer, and first transparent electrode patterns disposed over both regions of the non-contact surface of the front plate described above and the surface of the light shielding layer described above on a side opposite to the front plate described above as illustrated in FIG. 5 were formed.

<Formation of Insulating Layer>

(Preparation of Transfer Film W1 for Forming Insulating Layer)

In the preparation of transfer film E1 for etching, a transfer film W1 for forming an insulating layer in which the temporary support, the thermoplastic resin layer, the intermediate layer (an oxygen blocking film), the photocurable resin layer for an insulating layer, and the protective film were integrated with each other was obtained by the same preparation as that of the transfer film E1 for etching except that the etching resist E1 described above was changed to a coating liquid for forming an insulating layer formed of a formulation W1 described below (the film thickness of the photocurable resin layer for an insulating layer was 1.4 μm).

—Coating Liquid for Forming Insulating Layer: Formulation W1—
Binder 3 (1-Methoxy-2-Propanol of Glycidyl Methacrylate Adduct (d) of Cyclohexyl Methacrylate (a)/Methyl Methacrylate (b)/Methacrylic Acid Copolymer (c) (Composition (Mass %): a/b/c/d=46/1/10/43, Mass Average Molecular Weight: 36000, and Acid Value of 66 mgKOH/g), and Methyl Ethyl Ketone Solution (Solid Content: 45%)): 12.5 parts by mass
Propylene Glycol Monomethyl Ether Acetate Solution of Dipentaerythritol Hexaacrylate (DPHA, manufactured by Nippon Kayaku Co., Ltd.) (76 Mass %): 1.4 parts by mass
Urethane-Based Monomer (Product Name: NK OLIGO UA-32P, manufactured by Shin Nakamura Chemical Co., Ltd.: Non-Volatile Content of 75%, and Propylene Glycol Monomethyl Ether Acetate: 25%): 0.68 parts by mass
Tripentaerythritol Octaacrylate (Product Name: V#802, manufactured by OSAKA ORGANIC CHEMICAL INDUSTRY LTD.): 1.8 parts by mass
Diethyl Thioxanthone: 0.17 parts by mass
   2-(Dimethyl Amino)-2-[(4-Methyl Phenyl) Methyl]-1-[4-(4-Morphonyl) Phenyl]-1-Butanone (Product Name: Irgacure 379, manufactured by BASF SE): 0.17 parts by mass
Dispersing Agent (Product Name: SOLSPERSE 20000, manufactured by Nitto Denko Corporation): 0.19 parts by mass
Surfactant (Product Name: MEGAFAC F-780F, manufactured by DIC Corporation): 0.05 parts by mass
Methyl Ethyl Ketone: 23.3 parts by mass
MMPGAc (manufactured by Daicel Corporation): 59.8 parts by mass

Furthermore, the viscosity of the coating liquid W1 for forming an insulating layer at 100° C. after a solvent was removed therefrom was 4,000 Pa·sec.

The front plate attached with a white colored layer, a light shielding layer, and a first transparent electrode pattern described above was washed, and the transfer film W1 for forming an insulating layer from which the protective film was removed was laminated thereon (Substrate Temperature: 100° C., Rubber Roller Temperature of 120° C., Line Pressure of 100 N/cm, and Transport Speed of 2.3 m/minute). The temporary support was peeled off, and then, a distance between the surface of an exposure mask (a quartz exposure mask having a transparent electrode pattern) and the photocurable resin layer for etching described above was set to 100 μm, and pattern exposure was performed at an exposure amount of 30 mJ/cm² (an i line).

Next, a treatment was performed at 33° C. for 60 seconds by using a triethanol amine-based developer (a liquid in which T-PD2 (Product Name, manufactured by Fujifilm Corporation) containing 30 mass % of triethanol amine was diluted 10 times with pure water), a treatment was performed at 25° C. for 50 seconds by using a sodium carbonate/sodium hydrogen carbonate-based developer (a liquid in which T-CD1 (Product Name, manufactured by Fujifilm Corporation) was diluted 5 times with pure water), a treatment was performed at 33° C. for 20 seconds by using a surfactant-containing washing liquid (a liquid in which T-SD3 (Product Name, manufactured by Fujifilm Corporation) was diluted 10 times with pure water), and the residue was removed by a rotary brush and an ultra high pressure washing nozzle, and a postbaking treatment was further performed at 230° C. for 60 minutes, and thus, a front plate was obtained in which the white colored layer, the light shielding layer, the first transparent electrode pattern, and the insulating layer pattern were formed.

<Formation of Second Transparent Electrode Pattern>

(Formation of Transparent Electrode Layer)

As with the formation of the first transparent electrode pattern described above, the front plate in which the white colored layer, the light shielding layer, the first transparent electrode pattern, and the insulating layer pattern were formed was subjected to a DC magnetron sputtering treatment (Conditions: Temperature of Substrate of 50° C., Argon Pressure of 0.13 Pa, and Oxygen Pressure of 0.01 Pa), an ITO thin film having a thickness of 80 nm was formed, and thus, a front plate was obtained in which the white colored layer, the light shielding layer, the first transparent electrode pattern, the insulating layer pattern, and the transparent electrode layer were formed. The surface resistance of the ITO thin film was 110 Ω/□.

As with the formation of the first transparent electrode pattern, a front plate was obtained in which the white colored layer, the light shielding layer, the first transparent electrode pattern, the insulating layer pattern, the transparent electrode layer, and the photocurable resin layer pattern for etching were formed by using the transfer film E1 for etching (Postbaking Treatment; 130° C. for 30 minutes).

Further, as with the formation of the first transparent electrode pattern, etching (30° C. for 50 seconds) was performed, and the photocurable resin layer for etching was removed (45° C. for 200 seconds), and thus, a front plate was obtained in which the white colored layer, the light shielding layer, the first transparent electrode pattern, the insulating layer pattern, and second transparent electrode patterns disposed over both regions of the non-contact surface of the front plate described above and the surface of the light shielding layer described above on a side opposite to the front plate described above as illustrated in FIG. 5 were formed.

<Formation of Conductive Element Different from First Transparent Electrode Pattern and Second Transparent Electrode Pattern>

As with the formation of the first transparent electrode pattern and the second transparent electrode pattern described above, a front plate in which the white colored layer, the light shielding layer, the first transparent electrode pattern, the insulating layer pattern, and the second transparent electrode pattern were formed was subjected to a DC magnetron sputtering treatment, and thus, a front plate was obtained in which an aluminum (Al) thin film having a thickness of 200 nm was formed.

As with the formation of the first transparent electrode pattern and the second transparent electrode pattern described above, a front plate in which the white colored layer, the light shielding layer, the first transparent electrode pattern, the insulating layer pattern, the second transparent electrode pattern, the aluminum thin film, and the photocurable resin layer pattern for etching were formed was obtained by using the transfer film E1 for etching (Postbaking Treatment; 130° C. for 30 minutes).

Further, as with the formation of the first transparent electrode pattern, etching (30° C. for 50 seconds) was performed, and the photocurable resin layer for etching was removed (45° C. for 200 seconds), and thus, a front plate was obtained in which the white colored layer, the light shielding layer, the first transparent electrode pattern, the insulating layer pattern, the second transparent electrode pattern, and a conductive element different from the first transparent electrode pattern and the second transparent electrode pattern were formed.

<Formation of Transparent Protective Layer>

In a case where the substrate attached with a decorative material of Example 1 was used, a film was formed by spin coating of a coating liquid A described below such that the film thickness became 2 μm, and was set to a transparent protective layer, and thus, a front plate 1 which was laminated as illustrated in FIG. 5 was obtained. The obtained front plate 1 was set to an electrostatic capacitance type input device.

Coating Liquid A:

Compound 2 Described below (Epoxy Polymer): 58 parts by mass

Compound 4 Described below (Carboxylic Acid Polymer): 39 parts by mass

KBM-403 (manufactured by Shin-Etsu Chemical Co., Ltd.): 3 parts by mass

MEGAFAC F554 (manufactured by DIC Corporation) (Fluorine-Based Surfactant): 0.1 parts by mass

<<Synthesis Example of Compound 2>>

7 parts by mass of 2,2′-azobis-(2,4-dimethyl valeronitrile) and 200 parts by mass of diethylene glycol ethyl methyl ether were put into a flask provided with a cooling pipe and a stirrer. Subsequently, 12 parts by mass of a methacrylic acid (corresponding to 19.5 mol % in a polymer), 50 parts by mass of glycidyl methacrylate (corresponding to 49.4 mol %), 8 parts by mass of 3-ethyl (2-methacryloyl oxy methyl) oxetane (corresponding to 6.0 mol %), 10 parts by mass of N-cyclohexyl maleimide (corresponding to 7.9 mol %), 15 parts by mass of tetrahydrofurfuryl methacrylate (corresponding to 12.3 mol %), 5 parts by mass of acryloyl morpholine (corresponding to 4.9 mol %), and 2 parts by mass of pentaerythritol tetrakis(3-mercaptopropionate) were put thereinto, and nitrogen substitution was performed, and then, stirring was gently initiated. Polymerization was initiated at a time point where the temperature of a solution rose to 70° C. and the temperature of a reaction solution reached 70° C. After that, 3 parts by mass of N-cyclohexyl maleimide was dropped into the reaction solution after 30 minutes from the polymerization initiation, and 3 parts by mass of N-cyclohexyl maleimide was dropped into the reaction solution after 1 hour. After that, retainment was performed for 3 hours, and thus, a polymer solution containing a copolymer (a compound 2) was obtained. The weight-average molecular weight (Mw) of the compound 2 in terms of polystyrene was 9,000, and a molecular weight distribution (Mw/Mn) was 2.0.

<<Synthesis Example of Compound 4>>

A compound 4 denoted by the following structural formula was synthesized according to a synthesis method disclosed in JP5036269B.

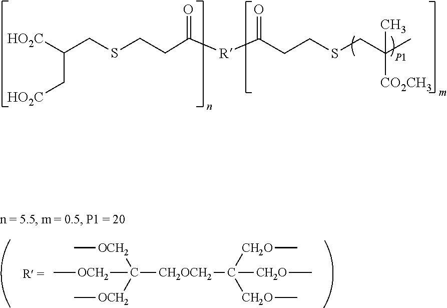

In addition, in a case where the substrates attached with a decorative material of the examples other than Example 1 were used, as with the formation of the insulating layer, the transfer film W1 for forming an insulating layer from which the protective film was removed was laminated on the front plate in which the white colored layer, the light shielding layer, the first transparent electrode pattern, the insulating layer pattern, the second transparent electrode pattern, and a conductive element different from the first transparent electrode pattern and the second transparent electrode pattern were formed, and the temporary support was peeled off, and then, front exposure was performed at an exposure amount of 50 mJ/cm² (an i line) without using an exposure mask, development, a postexposure treatment (1,000 mJ/cm²) and a postbaking treatment were performed, and thus, a front plate 1 was obtained in which the insulating layer (the transparent protective layer) was laminated to cover all of the white colored layer, the light shielding layer, the first transparent electrode pattern, the insulating layer pattern, the second transparent electrode pattern, and the conductive element different from the first transparent electrode pattern and the second transparent electrode pattern as illustrated in FIG. 5. The obtained front plate 1 was set to an electrostatic capacitance type input device.

<Preparation of Image Display Device (Touch Panel)>

The front plate 1 (the electrostatic capacitance type input device of each of the examples) manufactured in advance was bonded to a liquid crystal display element manufactured by a method disclosed in JP2009-47936A, and thus, an image display device 1 of Example 101 including the electrostatic capacitance type input device as a constituent was prepared by a known method.

<Total Evaluation of Front Plate 1 and Image Display Device 1>

In each step described above, in the front plate 1 (the electrostatic capacitance type input device of Example 101) in which the white colored layer, the light shielding layer, the first transparent electrode pattern, the insulating layer pattern, the second transparent electrode pattern, and the conductive element different from the first transparent electrode pattern and the second transparent electrode pattern were formed, the opening portion and the back surface were not contaminated, the washing was easily performed, and other members were not contaminated.

In addition, a pin hole was not generated in the white colored layer, and whiteness and unevenness did not occur. Similarly, a pin hole was not generated in the light shielding layer, and light shielding properties were excellent.

Then, there was no problem in the conductivity of each of the first transparent electrode pattern, the second transparent electrode pattern, and the conductive element different from the first transparent electrode pattern and the second transparent electrode pattern, and insulating properties were provided between the first transparent electrode pattern and the second transparent electrode pattern.

Further, a defect such as air bubbles did not occur in the transparent protective layer, and an image display device having excellent display properties and excellent operability was obtained.

### EXPLANATION OF REFERENCES

1: substrate (film substrate, only film substrate may be front plate)
1a: non-contact surface
1b: glass (cover glass, only cover glass may be front plate, and laminated body of substrate and glass may be front plate)
2a: white colored layer
2b: light shielding layer
2c: tilt portion
3: conductive layer (first transparent electrode pattern)
3a: pad portion
3b: connection portion
4: conductive layer (second electrode pattern)
5: insulating layer
6: conductive layer (other conductive element)
7: transparent protective layer
8: opening portion
10: electrostatic capacitance type input device
11: reinforced glass

What is claimed is:

1. A substrate attached with a decorative material, comprising:
a substrate;
a white colored layer;
a light shielding layer; and
a conductive layer, in this order,
wherein the substrate attached with a decorative material includes a light transmitting region transmitting light in a thickness direction, a decorative material configured of the white colored layer and the light shielding layer is laminated on the substrate to surround the light transmitting region and includes a tilt portion which is formed such that a thickness of the decorative material becomes thin towards the inside of the light transmitting region on an inner edge of the decorative material, and a tilt angle between a surface of the tilt portion and a surface of the substrate is 10 degrees to 60 degrees.

2. The substrate attached with a decorative material according to claim 1,
wherein the light shielding layer is a thermally crosslinking resin.

3. The substrate attached with a decorative material according to claim 2,
wherein the thermally crosslinking resin is a resin having a siloxane bond in a main chain.

4. The substrate attached with a decorative material according to claim 3,
wherein the resin having a siloxane bond in a main chain is a methyl silicone resin.

5. The substrate attached with a decorative material according to claim 1,
wherein the white colored layer contains a resin having a siloxane bond in a main chain.

6. The substrate attached with a decorative material according to claim 2,
wherein the white colored layer contains a resin having a siloxane bond in a main chain.

7. The substrate attached with a decorative material according to claim 3,
wherein the white colored layer contains a resin having a siloxane bond in a main chain.

8. The substrate attached with a decorative material according to claim 5,
wherein the resin having a siloxane bond in a main chain is a methyl silicone resin.

9. The substrate attached with a decorative material according to claim 6,
wherein the resin having a siloxane bond in a main chain is a methyl silicone resin.

10. The substrate attached with a decorative material according to claim 7,
wherein the resin having a siloxane bond in a main chain is a methyl silicone resin.

11. The substrate attached with a decorative material according to claim 1,
wherein a difference between a width of the white colored layer on the substrate side and a width of the light shielding layer is less than or equal to 200 μm.

12. The substrate attached with a decorative material according to claim 2,
wherein a difference between a width of the white colored layer on the substrate side and a width of the light shielding layer is less than or equal to 200 μm.

13. The substrate attached with a decorative material according to claim 3,
wherein a difference between a width of the white colored layer on the substrate side and a width of the light shielding layer is less than or equal to 200 μm.

14. The substrate attached with a decorative material according to claim 5,
wherein a difference between a width of the white colored layer on the substrate side and a width of the light shielding layer is less than or equal to 200 μm.

15. The substrate attached with a decorative material according to claim 8,
wherein a difference between a width of the white colored layer on the substrate side and a width of the light shielding layer is less than or equal to 200 μm.

16. A manufacturing method of the substrate attached with a decorative material according to claim 1, comprising:
a step of transferring a light shielding layer and a white colored layer onto a substrate from a film transfer material including at least a temporary support, the light shielding layer, and the white colored layer in this order, and then, removing the temporary support; or
a step of transferring a white colored layer onto a substrate from a film transfer material including a temporary support and the white colored layer, and then, removing the temporary support, and transferring a light shielding layer onto the white colored layer from a film transfer material including at least a temporary support and the light shielding layer, and then, removing the temporary support.

17. The manufacturing method of the substrate attached with a decorative material according to claim 16,
wherein the tilt portion is formed by contracting the light shielding layer.

18. The manufacturing method of the substrate attached with a decorative material according to claim 17,
wherein the tilt portion is formed by being heated at 50° C. to 300° C.

19. A touch panel, comprising:
the substrate attached with a decorative material according to claim 1.

20. An information display device, comprising:
the touch panel according to claim 19.
